(19) United States
(12) Patent Application Publication
(10) Pub. No.: US 2025/0379627 A1
(43) Pub. Date: Dec. 11, 2025

(54) CHANNEL STATE INFORMATION TRANSMISSION AND RECEPTION METHODS AND APPARATUSES AND COMMUNICATION SYSTEM

(71) Applicant: FUJITSU LIMITED, Kawasaki-shi (JP)

(72) Inventors: Qun ZHANG, Beijing (CN); Xin WANG, Beijing (CN)

(73) Assignee: FUJITSU LIMITED, Kawasaki-shi (JP)

(21) Appl. No.: 19/301,017

(22) Filed: Aug. 15, 2025

Related U.S. Application Data
(63) Continuation of application No. PCT/CN2023/076544, filed on Feb. 16, 2023.

(51) Int. Cl. H04B 7/06; H04B 7/0456; H04W 24/10

(52) U.S. Cl. CPC H04B 7/0626; H04B 7/0456; H04W 24/10

(57) ABSTRACT

Channel state information transmission and reception methods and apparatuses and a communication system. The channel state information transmission apparatus is applicable to a terminal equipment and includes: a receiver configured to receive first information transmitted by a network device, the first information including an allowable maximum value of a bitwidth of precoding matrix information, and/or information on a channel state information (CSI) generation model.

### CROSS-REFERENCE TO RELATED APPLICATION

This application is a continuation application under 35 U.S.C. 111(a) of International Patent Application PCT/CN2023/076544 filed on Feb. 16, 2023, and designated the U.S., the entire contents of which are incorporated herein by reference.

### TECHNICAL FIELD

This disclosure relates to the field of communication technologies.

### BACKGROUND

Multiple-input multiple-output (MIMO) technology is one of the key technologies for 5G mobile communication. MIMO is able to provide higher channel capacity, but the realization of the benefit depends on whether accurate channel state information may be acquired.

In the MIMO technology, a terminal equipment measures spatial channels and feeds channel state information (CSI) back to a network device. According to the channel state information reported by the terminal equipment, the network device may select an appropriate precoding matrix suitable for the terminal equipment in performing downlink transmission, thereby reducing a probability of receiving bit errors of the terminal equipment as much as possible.

A channel state information generation and feedback process may be summarized as follows. The network device transmits channel state information reference signals (CSI-RSs) to terminal equipments, and the terminal equipments estimate channels based on the received CSI-RSs to obtain estimation of a spatial channel matrix. The terminal equipments further utilize the estimated spatial channels to obtain CSI. In the New Radio (NR) technology, a feedback mode of CSI is implicit feedback, that is, the terminal equipments provide CSI in a form of recommending transmission parameters to the network device, the transmission parameters including a channel state information reference signal resource indicator (CQI), a precoding matrix indicator (PMI), a CSI-RS resource indicator (CRI), a synchronization signal block resource indicator (SSBRI), a layer indicator (LI), a rank indicator (RI), and physical layer RSRP (L1-RSRP), etc. A base station may directly use the parameters recommended by the terminal equipment to perform downlink transmission, or, it may not use the recommended parameters.

In a frequency division duplex (FDD) system, for a downlink, when the network device uses information of downlink channels for precoding, the terminal equipment is needed to feed back the downlink channel state information to the network device via an uplink. However, as the information of downlink channels is proportional to the number of antennas of the network device, in a scenario of massive MIMO, the huge number of antennas of the network device will lead to a very large amount of feedback on the channel state information of the downlink channels. Enhanced codebooks (such as Type II codebooks) for downlink feedback has been designed in the Third Generation Partnership Project (3GPP), in which feedback amount of channel state information is reduced through frequency domain compression. However, for valuable uplink resources, there is still a need to further reduce the amount of uplink feedback.

With the development of artificial intelligence/machine learning (AI/ML) technologies, applying the AI/ML technologies to physical layers of wireless communication to solve difficulties in conventional methods has become a current technological direction.

FIG. 1 is a schematic diagram of CSI feedback based on AI/ML. An AI/ML module may include an AI/ML-based CSI generation portion and an AI/ML-based CSI reconstruction portion, wherein the AI/ML-based CSI generation portion includes an AI/ML model, the AI/ML model including an AI/ML encoder and a quantizer. In addition, and further including a preprocessing module. The AI/ML-based CSI reconstruction portion includes an AI/ML reconstruction model, the AI/ML reconstruction model including a quantizer and an AI/ML decoder, and further including a post-processing module.

As shown in FIG. 1, in operation 101, the terminal equipment side uses the AI/ML-based CSI generation portion to perform processing and obtains CSI, and the network device receives the CSI via air interface; and in operation 102, the network device uses the AI/ML-based CSI reconstruction portion to process the received CSI, and obtains recovered CSI.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that in the related art, methods for CSI feedback based on AI/ML have not been standardized, hence, there is a need to set unified methods for CSI feedback based on AI/ML.

In order to solve at least one of the above problems or other similar problems, embodiments of this disclosure provide channel state information transmission and reception methods and apparatuses and a communication system, in which methods for CSI feedback based on AI/ML are normalized, thereby ensuring gains of the methods for CSI feedback based on AI/ML with respect to performances and overhead, and improving throughput of 5G and/6G wireless communications.

According to one aspect of the embodiments of this disclosure, there is provided a channel state information transmission apparatus, applicable to a terminal equipment, the apparatus including:
a first receiving portion configured to receive first information transmitted by a network device, the first information including an allowable maximum value of a bitwidth of precoding matrix information, and/or information on a channel state information (CSI) generation model.

According to another aspect of the embodiments of this disclosure, there is provided a channel state information transmission apparatus, applicable to a terminal equipment, the apparatus including:
a first receiving portion configured to receive a channel state information reference signal (CSI-RS) transmitted by a network device;
a first processing portion configured to measure channel information based on the CSI-RS and first configuration, and generate CSI; and
a first transmitting portion configured to transmit the CSI and/or information on a decision of the terminal equipment to the network device.

According to a further aspect of the embodiments of this disclosure, there is provided a channel state information reception apparatus, applicable to a network device, the apparatus including:
a second transmitting portion configured to transmit first information to a terminal equipment, the first information including an allowable maximum value of a bitwidth of precoding matrix information, and/or information on a channel state information (CSI) generation model.

According to still another aspect of the embodiments of this disclosure, there is provided a channel state information reception apparatus, applicable to a network device, the apparatus including:
a second transmitting portion configured to transmit a channel state information reference signal (CSI-RS) to a terminal equipment; and
a second receiving portion configured to receive channel state information (CSI) and/or information on a decision of the terminal equipment transmitted by the terminal equipment,
wherein the CSI is generated according to measurement channel information obtained based on the CSI-RS and first configuration.

An advantage of the embodiments of this disclosure exists in that methods for CSI feedback based on AI/ML are normalized, thereby ensuring gains of the methods for CSI feedback based on AI/ML with respect to performances and overhead, and improving throughput of 5G and/6G wireless communications.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of performing CSI feedback based on AI/ML;

FIG. 2 is a schematic diagram of a communication system of this disclosure;

FIG. 3 is a schematic diagram of a channel state information (CSI) transmission method of a first aspect of this disclosure;

FIG. 4 is another schematic diagram of the channel state information (CSI) transmission method of the first aspect of this disclosure;

FIG. 5 is a schematic diagram of a channel state information (CSI) transmission method of a second aspect of this disclosure;

FIG. 6 is another schematic diagram of the channel state information (CSI) transmission method of the second aspect of this disclosure;

FIG. 7 is a schematic diagram of a channel state information (CSI) transmission apparatus of a third aspect of this disclosure;

FIG. 8 is a schematic diagram of a channel state information (CSI) transmission apparatus of a fourth aspect of this disclosure;

FIG. 9 is a schematic diagram of a terminal equipment of a fifth aspect of this disclosure; and

FIG. 10 is a schematic diagram of a network device of the fifth aspect of this disclosure.

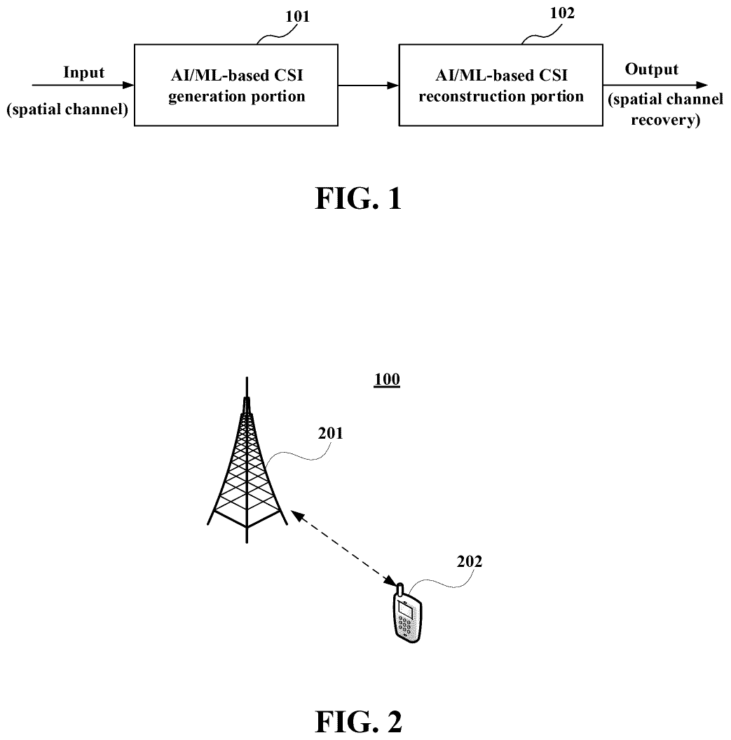

### DETAILED DESCRIPTION

These and further aspects and features of this disclosure will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, 5G, and new radio (NR), etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: integrated access and backhaul node (IAB-node), a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IOT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above.

In the following description, without causing confusion, the terms “uplink control signal” and “uplink control information (UCI)” or “physical uplink control channel (PUCCH)” are replaced with each other, and terms “uplink data signal” and “uplink data information” or “physical uplink shared channel (PUSCH)” are replaced with each other.

The terms “downlink control signal” and “downlink control information (DCI)” or “physical downlink control channel (PDCCH)” are replaced with each other, and the terms “downlink data signal” and “downlink data information” or “physical downlink shared channel (PDSCH)” are replaced with each other.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. The uplink signal may include an uplink data signal and/or an uplink control signal, etc., and may be referred to as uplink transmission or uplink information or an uplink channel. Transmitting uplink transmission on an uplink resource may be understood as transmitting the uplink transmission by using the uplink resource. Likewise, downlink data/signal/channel/information may be understood correspondingly.

In the embodiments of this disclosure, high-layer signaling may be, for example, radio resource control (RRC) signaling; for example, it is referred to an RRC message, which includes an MIB, system information, and a dedicated RRC message; or, it is referred to an as an RRC information element (RRC IE). High-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

FIG. 2 is a schematic diagram of a communication system of this disclosure, in which a case where a terminal equipment and a network device are taken as examples is schematically shown. As shown in FIG. 2, the communication system 100 may include a network device 201 and a terminal equipment 202 (for the sake of simplicity, an example having only one terminal equipment is schematically given in FIG. 2).

In the embodiment of this disclosure, existing traffics or traffics that may be implemented in the future may be performed between the network device 201 and the terminal equipment 202. For example, such traffics may include but not limited to enhanced mobile broadband (eMBB), massive machine type communication (MTC), and ultra-reliable and low-latency communication (URLLC), etc.

The terminal equipment 202 may transmit data to the network device 201, such as in a grant or grant-free manner. The network device 201 may receive data transmitted by one or more terminal equipments 202, and feed back information to the terminal equipment 202, such as acknowledgement (ACK)/non-acknowledgement (NACK) information, and the terminal equipment 202 may acknowledge to terminate a transmission process, or may perform transmission of new data, or may perform data retransmission.

In the following description of this disclosure, an artificial intelligence (AI) model may also be referred to as an artificial intelligence/machine learning (AI/ML) model, and they are replaced with each other.

In the embodiments described below, signaling transmitted by the network device to the terminal equipment may be transmitted via downlink control information (DCI), a media access control control element (MAC CE), and/or radio resource control (RRC) signaling.

In the following embodiments of this disclosure, there exists a pairing relationship between an AI/ML-based CSI generation portion and an AI/ML-based CSI reconstruction portion, the former being applicable to a terminal equipment side, and the latter being applicable to a network device side. If the terminal equipment uses an AI/ML-based CSI generation portion, the network device may use an AI/ML-based CSI reconstruction portion paired with the AI/ML-based CSI generation portion to successfully reconstruct channel information. And if the network device uses an AI/ML-based CSI reconstruction portion, the terminal equipment may use an AI/ML-based CSI generation portion paired with the AI/ML-based CSI reconstruction portion to successfully reconstruct channel information at the network device side.

The AI/ML-based CSI generation portion includes an AI/ML model, which may be used to generate one or more of precoding matrix information, a rank indicator (RI), a layer indicator (LI), a channel resource indicator (CRI), and a channel quality indicator (CQI). In addition, the RI, LI, CRI and CQI may not be generated by the AI/ML model. For example, the AI/ML-based CSI generation portion may further include one or more of a module generating an RI, a module generating an LI, a module generating a CRI, and a module generating a CQI. The AI/ML-based CSI generation portion may further include other modules, such as a module for truncating bit sequences.

The information of the AI/ML-based CSI generation portion may be composed of AI/ML model information and/or information of the module generating an RI and/or information of the module generating an LI and/or information of the module generating a CRI and/or information of the module generating a CQI and/or information of a module truncating a bit sequence and/or information of other functional modules (if any).

The AI/ML model may include three parts, a preprocessing module, an AI/ML encoder and a quantizer. Therefore, AI/ML model information may include preprocessing module information, AI/ML encoder information and quantizer information. For example, the AI/ML model information may be described by “preprocessing module #2, AI/ML encoder #4, quantizer #A”. In addition, the preprocessing module, AI/ML encoder and quantizer may be regarded as a whole to annotate the AI/ML model information, that is, the AI/ML model information may also be expressed as, for example, AI/ML model information #4, etc.

The AI/ML-based CSI reconstruction model of the AI/ML-based CSI reconstruction portion paired with the AI/ML-based CSI generation portion may also include three parts, a dequantizer, an AI/ML decoder, and a post-processing module. Therefore, the AI/ML reconstruction model information may include dequantizer information, AI/ML decoder information, and post-processing module information. For example, the AI/ML reconstruction model information may be described by “dequantizer #B, AI/ML decoder #1, post-processing module #2”. In addition, the AI/ML reconstruction model information may also be expressed as, for example, AI/ML reconstruction model #1, or AI/ML model #1 in brief, so as to express the pairing relationship with AI/ML model #1 in the AI/ML-based CSI generation portion.

The AI/ML model may also be composed of two parts (for example, it has no preprocessing module, or a preprocessing module is included in the AI/ML encoder and is regarded as a whole with the AI/ML encoder), that is, the AI/ML model includes an AI/ML encoder and a quantizer. At this point, the AI/ML model information may be composed of AI/ML encoder information and quantizer information. The AI/ML-based CSI reconstruction model of the AI/ML-based CSI reconstruction portion paired with the AI/ML model may also consist of two parts, a quantizer and an AI/ML decoder. At this point, the AI/ML reconstruction model information consists of quantizer information and AI/ML decoder information. The preprocessing module may be included in the AI/ML encoder, or may not be included in the AI/ML encoder. The post-processing module may be included in the AI/ML decoder or may not be included in the AI/ML decoder.

The AI/ML model may also be composed of one part, that is, the AI/ML encoder and quantizer are regarded as a whole (for example, the AI/ML encoder and quantizer are inseparable and cannot be freely combined), and the AI/ML encoder may or may not include a preprocessing module. At this point, the AI/ML model information consists of one part only, for example, the AI/ML model information is AI/ML model #5. The AI/ML reconstruction model may also be composed of one part, that is, the quantizer and AI/ML decoder are regarded as a whole (for example, the AI/ML decoder and quantizer are inseparable and cannot be freely combined), and the AI/ML decoder may or may not include a post-processing module. At this point, the AI/ML reconstruction model information consists of one part only, for example, the AI/ML reconstruction model information is AI/ML reconstruction model #5, or AI/ML model #5 in brief, so as to express the pairing relationship with AI/ML model #5 in the AI/ML-based CSI generation portion.

In the embodiments of this disclosure, it is assumed that frequency domain resources are fixed, that is, carrier frequencies, subcarrier spacings and bandwidths are fixed. In addition, this disclosure is not limited thereto. For example, description of the embodiments are also applicable to scenarios where at least one of a carrier frequency, a subcarrier spacing and a bandwidth is not fixed.

In the embodiments of this disclosure, reporting may refer to an action of transmitting information by the terminal equipment to the network device. For example, reporting CSI by the terminal equipment may refer to transmitting CSI by the terminal equipment to the network device.

### Embodiments of a First Aspect

The embodiments of the first aspect of this disclosure describe a process of performing CSI feedback based on AI/ML. The process includes configuration of a network device (such as the network device 201 in FIG. 2) and reporting of a terminal equipment (such as the terminal equipment 202 in FIG. 2). The network device may configure CSI reporting configuration information to the terminal equipment, including an allowable maximum value of a bitwidth of precoding matrix information (for example, the allowable maximum value of a bitwidth of precoding matrix information may also be referred to as a maximum bitwidth of precoding matrix information) and/or information of the CSI generation model and/or frequency domain reporting configuration (e.g. the frequency domain reporting configuration includes a frequency domain granularity, such as the number of subbands) and/or codebook configuration (including Type-I, Type II, enhanced Type II CSI, or further enhanced Type II port selection codebook, configuration parameters and group-based reporting configuration of precoding matrix information generated in an AI/ML method) and/or other configurations (for example, the other configurations include at least one of the following: a reporting configuration ID, a channel measurement resource, a CSI-IM interference measurement resource, a reporting configuration type, reportQuantity, a time domain restriction for channel measurement, a time domain restriction for interference measurement, a CQI table, groupBasedBeamReporting). The terminal equipment receives the CSI-RS transmitted by the network device, measures channel information based on the CSI reporting configuration, generates CSI, and transmits the CSI to the network device based on the CSI reporting configuration. At least a part of information of the CSI is generated in an AI/ML-based method and/or a traditional codebook method.

Detailed description shall be given below.

The embodiments of the first aspect provide a channel state information (CSI) transmission method, applicable to a terminal equipment. In the following description, a network device may be, for example, the network device 201 in FIG. 2, and the terminal equipment may be, for example, the terminal equipment 202 in FIG. 2.

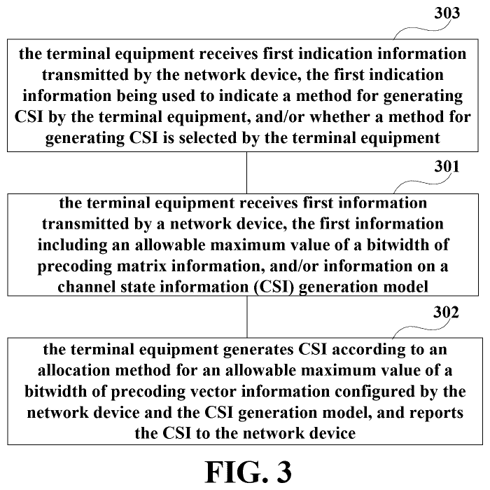

FIG. 3 is a schematic diagram of the channel state information transmission method in the first aspect of this disclosure. As shown in FIG. 3, the method includes:
operation 301: the terminal equipment receives first information transmitted by a network device, the first information including an allowable maximum value of a bitwidth of precoding matrix information, and/or information on a channel state information (CSI) generation model.

The method shown in FIG. 3 is used to explain configuration by the network device for the terminal equipment.

In some embodiments, at least a part of the first information is configured in CSI reporting configuration. At least a part of the first information is configured in first configuration. For example, the first configuration includes a maximum of a size of a payload of uplink control information (UCI) and/or information of the CSI generation model. The precoding matrix information in the first information is at least a part of information in the payload of the uplink control information (UCI).

For example, the terminal equipment receives the first configuration transmitted by the network device, the first configuration including the maximum value of the payload size of the UCI, and/or information of the CSI generation model, and/or indication information. The indication information indicates that the terminal equipment reports second information, the second information including the information of the CSI generation model and/or a method for allocating the allowable maximum value of the bitwidth of the precoding matrix information. The terminal equipment receives the CSI-RS transmitted by the network device, measures the channels, and generates the CSI. Thereafter, the terminal equipment transmits the CSI and/or the second information to the network device. The payload of UCI may include the CSI.

In some embodiments, the CSI includes precoding matrix information. In some embodiments, at least a part of the second information is included in the CSI; or, at least a part of the second information is part of the UCI but is not included in the CSI; or, at least a part of the second information is transmitted to the network device via RRC.

In some embodiments, the precoding matrix information involved in operation 301 is generated by the terminal equipment based on the CSI generation model or a codebook according to configuration related to the precoding matrix configured by the network device, wherein the CSI generation model is, for example, an artificial intelligence model.

For example, in generating the precoding matrix information by using the artificial intelligence model, the precoding matrix information may also be referred to as AI/ML-based precoding matrix information. The AI/ML-based precoding matrix information is obtained by the terminal equipment by processing downlink channel matrix information measured by the terminal equipment via the AI/ML-based CSI generation portion. Output of the AI/ML-based CSI generation portion includes at least one of AI/ML-based precoding matrix information, a layer indicator (LI), a channel quality indicator (CQI), a rank indicator (RI), and a channel state information reference signal resource indicator (CRI). The downlink channel matrix information may be a downlink channel matrix, may be a right singular vector and/or eigenvector of a downlink channel matrix, or may be an other results of processing the downlink channel matrix, such as a result of performing two-dimensional inverse Fourier transform on the downlink channel matrix; however, it is not limited thereto. The downlink channel matrix is obtained by the terminal equipment by measuring the downlink channel via the channel state information reference signal (CSI-RS).

In some embodiments, the allowable maximum value of the bitwidth of the precoding matrix information (or the maximum bitwidth of the precoding matrix information) is set based on the number of layers and/or a frequency domain granularity of downlink transmission between the terminal equipment and the network device, wherein the frequency domain granularity is, for example, the number of subbands.

In some embodiments, when the terminal equipment has only one layer of downlink transmission, the allowable maximum value of the bitwidth of the precoding matrix information is an allowable maximum value of a bitwidth of precoding vector information of the downlink transmission layer. In a case where the terminal equipment has more than one downlink transmission layer, the allowable maximum value of the bitwidth of the precoding matrix information is a sum of allowable maximum values of bitwidths of precoding vector information of downlink transmission (or maximum bitwidths of the precoding vector information) of the more than one layer.

In some embodiments, in the case where the terminal equipment has more than one downlink transmission layer, the terminal equipment may set an allowable maximum value of a bitwidth of precoding vector information of each transmission layer. For example, the terminal equipment sets the allowable maximum values of the bitwidths of the precoding vector information of the transmission layers according to an allocation method configured by the network device or according to a predetermined allocation method or according to an allocation method determined by the terminal equipment itself.

The above allocation method configured by the network device for the terminal equipment may be at least one of the following method 1, method 2 or method 3:
method 1: allowable maximum values of bitwidths of precoding vector information of all transmission layers are identical, and furthermore, the allowable maximum values of the bitwidths of the precoding vector information of all transmission layers are identical and fixed;
method 2: allowable maximum values of bitwidths of precoding vector information of at least two transmission layers are different; and
method 3: one or more first schemes, wherein at least one first scheme includes information on an allowable maximum value of a bitwidth of precoding vector information of each transmission layer in all transmission layers; in method 3, at least one downlink transmission layer may be configured with more than two first schemes.

In some embodiments, in the case where the allocation method is the above method 2, the terminal equipment further sets the allowable maximum value of the bitwidth of the precoding vector information of each transmission layer by using a second scheme determined by the terminal equipment, and transmits information on the determined second scheme to the network device; or, the terminal equipment sets the allowable maximum value of the bitwidth of the precoding vector information of each transmission layer by using a second scheme that is agreed or specified in a protocol.

The determining the second scheme by the terminal equipment may refer to that: the terminal equipment selects a scheme from the more than one candidate second scheme and takes it as a determined second scheme, the candidate second schemes being configured by the network device, or being agreed upon by the network device and the terminal equipment, or being specified in a protocol; or, the terminal equipment may determine the second scheme according to the CSI generation model used by the terminal equipment. For example, the terminal equipment may set the allowable maximum values of the bitwidths of the precoding vector information of the transmission layers according to an output bitwidth of the CSI generation model, thereby determining the second scheme.

In some embodiments, when the terminal equipment has only one downlink transmission layer, the terminal equipment selects a CSI generation model corresponding to the downlink transmission layer according to the allowable maximum value of the bitwidth of the precoding matrix information. Furthermore, the terminal equipment may transmit information on the CSI generation model used for the downlink transmission layer to the network device.

In some embodiments, when the terminal equipment has more than one downlink transmission layer, the terminal equipment selects CSI generation models for the downlink transmission layers according to the allowable maximum value of the bitwidth of the precoding vector information of each downlink transmission layer. Furthermore, the terminal equipment transmits information on the CSI generation model used for each of the downlink transmission layers to the network device; or, when all the downlink transmission layers use identical CSI generation models, the terminal equipment transmits information on the identical CSI generation models to the network device, and the terminal equipment transmits information to the network device to indicate that all the downlink transmission layers use identical CSI generation models. Thus, the network device may determine information on the CSI generation model to which each downlink transmission layer of the terminal equipment corresponds.

In some embodiments, in the case where the terminal equipment has more than one downlink transmission layer, the information on the CSI generation model included in the first information received from the network device includes that at least two downlink transmission layers use different CSI generation models, or, all downlink transmission layers use identical CSI generation models.

The allowable maximum values of the bitwidths of the precoding vector information of all the downlink transmission layers are identical, or the allowable maximum values of the bitwidths of the precoding vector information of at least two downlink transmission layers are different. For example, the allowable maximum value of the bitwidth of the precoding vector information of each downlink transmission layer may be determined in a manner as follows: the terminal equipment determines an allowable maximum value of a bitwidth of precoding vector information of at least one downlink transmission layer, and transmits the determined allowable maximum value of the bitwidth to the network device; and/or, an allowable maximum value of a bitwidth of precoding vector information of at least one downlink transmission layer is configured by the network device; and/or, an allowable maximum value of a bitwidth of precoding vector information of at least one downlink transmission layer is specified in a protocol.

In some embodiments, the first information in operation 301 further includes frequency domain reporting configuration, and/or codebook configuration, wherein the frequency domain reporting configuration includes a frequency domain granularity.

In some embodiments, the first information in operation 301 may further include at least one of the following information:
a reporting configuration identifier, a channel measurement resource, a channel state information-interference measurement (CSI-IM) resource, a reporting configuration type, a reporting quantity, a time domain limit of channel measurement, a time domain limit of interference measurement, a channel quality indication (CQI) table, or group based beam reporting (groupBasedBeamReporting).

In some embodiments, as shown in FIG. 3, the channel state information transmission method may further include:
operation 302: the terminal equipment generates CSI according to an allocation method for an allowable maximum value of a bitwidth of precoding vector information configured by the network device and the CSI generation model, and reports the CSI to the network device.

In operation 302, when the allowable maximum value of the bitwidth of the precoding vector information of the at least one transmission layer is less than the number of bits output by the CSI generation model of the transmission layer, processing is performed to ensure that the number of bits output by the CSI generation model is less than or equal to the allowable maximum value of the bitwidth of the precoding vector information of the transmission layer. The processing may be a truncation process for bits.

A mode for the processing may be set by the terminal equipment and transmitted to the network device; or, a manner for the processing may be configured by the network device or is specified in a protocol.

In operation 302, when the number of uplink resources used to report the precoding matrix information is less than the allowable maximum value of the bitwidth of the precoding matrix information, the CSI is discarded. For example, the CSI may be discarded according to a priority reported by the CSI.

A mode for discarding may be set by the terminal equipment and transmitted to the network device; or, a manner for discarding may be configured by the network device or is specified in a protocol.

In some embodiments, as shown in FIG. 3, the channel state information transmission method may further include:
operation 303: the terminal equipment receives first indication information transmitted by the network device, the first indication information being used to indicate a method for generating CSI by the terminal equipment, and/or whether a method for generating CSI is selected by the terminal equipment.

The first indication information being used to indicate a method for generating CSI by the terminal equipment is, for example, generating CSI by using the CSI generation model (i.e. generating CSI based on an artificial intelligence model), or generating CSI based on a codebook (i.e. a traditional codebook method).

The first indication information being used to indicate whether a method for generating CSI is selected by the terminal equipment is, for example, selecting by the terminal equipment to use a CSI generation model to generate CSI (i.e. generating CSI based on an artificial intelligence model) or generating CSI based on a codebook; or, not selecting a method for generating CSI by the terminal equipment.

In some embodiments, the first indication information is included in the codebook configuration transmitted by the network device to the terminal equipment. In some other embodiments, the first indication information is included in the CSI reporting configuration transmitted by the network device to the terminal equipment.

With the first indication information, the terminal equipment is able to execute the CSI feedback method based on coexistence of traditional codebooks and AI/ML. The CSI feedback method based on coexistence of traditional codebooks and AI/ML may be compatible with existing wireless communication standards and devices on the one hand, and on the other hand, flexible switching between a traditional codebook method and an AI/ML method may be achieved. Furthermore, when the AI/ML-based CSI feedback method fails, the traditional codebook method may be reserved available, thereby ensuring normal operation of the communication system.

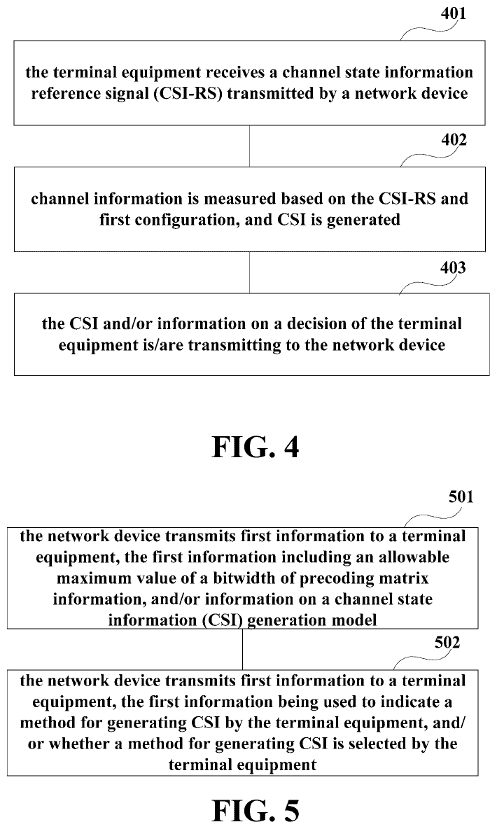

FIG. 4 is another schematic diagram of the channel state information (CSI) transmission method of the first aspect of this disclosure. As shown in FIG. 4, the method includes:
operation 401: the terminal equipment receives a channel state information reference signal (CSI-RS) transmitted by a network device;
operation 402: channel information is measured based on the CSI-RS and first configuration, and CSI is generated; and
operation 403: the CSI and/or information on a decision of the terminal equipment are/is transmitted to the network device.

The method shown in FIG. 4 is used to explain reporting of the CSI by the terminal equipment.

In operation 402, description the first configuration is identical to that in operation 301. The first configuration includes channel state information (CSI) reporting configuration and/or configuration based on radio resource control (RRC) signaling transmission.

In operation 402, at least a part of information of the CSI is generated in a method based on an artificial intelligence model and/or a method based on codebooks.

In operation 403, the information on a decision of the terminal equipment may include an allocation method of an allowable maximum value of a bitwidth of precoding matrix information determined by the terminal equipment, and/or information on a CSI generation model determined by the terminal equipment.

In some embodiments of operation 403, the terminal equipment transmits the CSI and/or the information on a decision of the terminal equipment to the network device based on at least one of CSI reporting configuration, the first configuration or configuration of RRC signaling transmission.

For example, the terminal equipment transmits the CSI and/or the information on a decision of the terminal equipment to the network device via uplink control information (UCI) and/or RRC signaling.

The channel state information (CSI) transmission method shown in FIG. 3 and FIG. 4 shall be described below with reference to embodiments.

### Embodiment 1

In embodiment 1, the network device configures the terminal equipment with the allowable maximum value of the bitwidth and/or the frequency domain granularity of the precoding matrix information (e.g. AI/ML-based precoding matrix information), such as the number of subbands.

In some implementations, there may be more than one allowable maximum value of bitwidths of AI/ML-based precoding matrix information configured by the network device. The configured allowable maximum values of bitwidths of AI/ML-based precoding matrix information are related to the number of downlink transmission layers, and may also be related to the number of subbands. For example, an allowable maximum number of downlink transmission layers is a positive integer N≥1, and the allowable maximum value of the bitwidth of the precoding matrix information configured by the network device includes one or more possibilities of actual downlink transmission layers. The terminal equipment learns the allowable maximum value of the bitwidth of the AI/ML-based precoding matrix information according to a rank of a downlink channel matrix measured by it and/or a rank indicator (RI) reported by it and/or the number of downlink transmission layers and/or a frequency domain granularity configured by the network device, such as the number of subbands. For example, N=4, and the allowable maximum value of the bitwidth of the AI/ML-based precoding matrix information configured by the network device for the terminal equipment is as shown in Table 1 below.

TABLE 1

| Number M | | Allowable maximum value of |
|---|---|---|
| of downlink | Number N_{sb} | the bitwidth of the AI/ML-based |
| transmission layers | of subbands | precoding matrix information |
| 1 | 13 | 120 bits |
| | 26 | 150 bits |
| 2 | 13 | 220 bits |
| | 26 | 260 bits |
| 3 | 13 | 300 bits |
| | 26 | 370 bits |
| 4 | 13 | 380 bits |
| | 26 | 450 bits |

If the rank of the downlink channel matrix measured by the terminal equipment is 2 and the number of subbands is 13, the payload of the CSI is 220 bits. For another example, N=7, and the allowable maximum value of the bitwidth of the AI/ML-based precoding matrix information configured by the network device for the terminal equipment may not include all possibilities of the downlink transmission layers, as shown in Table 2 below.

TABLE 2

| Number M | | Allowable maximum value of |
|---|---|---|
| of downlink | Number N_{sb} | the bitwidth of the AI/ML-based |
| transmission layers | of subbands | precoding matrix information |
| 1 | 12 | 100 bits |
| | 24 | 90 bits |
| 2 | 12 | 200 bits |
| | 24 | 190 bits |
| 3 | 12 | 260 bits |
| | 24 | 255 bits |
| 5 | 12 | 340 bits |
| | 24 | 336 bits |
| 6 | 12 | 390 bits |
| | 24 | 385 bits |

For cases where they are not configured, that is, M=4,7, the terminal equipment may determine the allowable maximum value of the bitwidth of the AI/ML-based precoding matrix information and report it to the network device. The terminal equipment may determine the allowable maximum value of the bitwidth of the AI/ML-based precoding matrix information according to Table 2, that is, on the premise the numbers of subbands are identical, an allowable maximum value of the bitwidth of the AI/ML-based precoding matrix information to which M=4 corresponds is not less than an allowable maximum value of the bitwidth of the AI/ML-based precoding matrix information to which M =3 corresponds and is not greater than a payload to which M =5 corresponds, and an allowable maximum value of the bitwidth of the AI/ML-based precoding matrix information to which M =7 corresponds is not less than a payload to which M=6 corresponds. The terminal equipment may also not determine the allowable maximum value of the bitwidth of the AI/ML-based precoding matrix information according to Table 2, that is, even if the numbers of subbands are identical, an allowable maximum value of the bitwidth of the AI/ML-based precoding matrix information to which at least one of M=4,7 corresponds does not satisfy a monotonic increasing relation of an allowable maximum value of a bitwidth of AI/ML-based precoding matrix information along with N. In some implementations, possibilities Np of allowable maximum values of the bitwidth of the AI/ML-based precoding matrix information configured by the network device for each N is more than one (Nₚ>1), and the network device selects one or a combination of the Nₚ possibilities and configures it for the terminal equipment.

Configuration of the Nₚ possibilities may be specified in standards, or may be agreed upon by the network device and the terminal equipment, or may be determined by the network device or the terminal equipment. For example, the allowable maximum value of the bitwidth of the AI/ML-based precoding matrix information configured by the network device for the terminal equipment is specified in standards, as shown in Table 3 below.

TABLE 3

| | | Allowable | Allowable | Allowable |
|---|---|---|---|---|
| | | maximum value #1 | maximum value #2 | maximum value #3 |
| Number M | | of the bitwidth of | of the bitwidth of | of the bitwidth of |
| of downlink | Number | the AI/ML-based | the AI/ML-based | the AI/ML-based |
| transmission | N_{sb} of | precoding matrix | precoding matrix | precoding matrix |
| layers | subbands | information | information | information |
| 1 | 13 | 120 bits | 125 bits | 105 bits |
| | 26 | 150 bits | 160 bits | 140 bits |
| 2 | 13 | 220 bits | 230 bits | 201 bits |
| | 26 | 260 bits | 270 bits | 240 bits |
| 3 | 13 | 300 bits | 301 bits | 252 bits |
| | 26 | 360 bits | 366 bits | 311 bits |
| 4 | 13 | 380 bits | 357 bits | 298 bits |
| | 26 | 440 bits | 431 bits | 383 bits |

The network device configures the allowable maximum value #2 of the bitwidth of the AI/ML-based precoding matrix information for the terminal equipment.

The number of downlink transmission layers is M=4, the number of subbands is N_{sb}=13, and the terminal equipment learns that the allowable maximum value of the bitwidth of the AI/ML-based precoding matrix information is 357 bits. In some implementations, the network device configures the number of downlink transmission layers and/or the number of subbands, at this time, the network device configures the allowable maximum value of the bitwidth of the AI/ML-based precoding matrix information only for the number of downlink transmission layers and/or the number of subbands configured by itself, and the number of possibilities of the configured allowable maximum value of the bitwidth of the AI/ML-based precoding matrix information may be one or more.

For example, the number of downlink transmission layers configured by the network device is 2 and the number of subbands is 13, and the configured allowable maximum value of the bitwidth of the AI/ML-based precoding matrix information is 234 bits, which is a sum of allowable maximum values of bitwidths of “precoding vector information of an AI/ML-based transmission layer” of two transmission layers. For another example, the number of downlink transmission layers configured by the network device is 1 and the number of subbands is 12, and the allowable maximum value of the bitwidth of the AI/ML-based precoding matrix information configured for the terminal equipment is as shown in Table 4 below.

TABLE 4

| | | Allowable | Allowable | Allowable | Allowable |
|---|---|---|---|---|---|
| | | maximum value #1 | maximum value #2 | maximum value #3 | maximum value #4 |
| Number M | | of the bitwidth of | of the bitwidth of | of the bitwidth of | of the bitwidth of |
| of downlink | Number | the AI/ML-based | the AI/ML-based | the AI/ML-based | the AI/ML-based |
| transmission | N_{sb} of | precoding matrix | precoding matrix | precoding matrix | precoding matrix |
| layers | subbands | information | information | information | information |
| 1 | 12 | 120 bits | 125 bits | 105 bits | 100 bits |

In some implementations, there may be one or more modes for discarding CSI. The modes for discarding CSI may be agreed upon by the network device and the terminal equipment, or may be specified by the network device, or may be specified by the terminal equipment, or may be specified in standards. For a case where there is only one mode for discarding CSI, the terminal equipment may discard CSI according to the mode for discarding CSI, without needing to report to the network device. For a case where there are ore or more modes for discarding CSI, the modes for discarding CSI may be configured by the network device, or may be determined by the terminal equipment and reported to the network device. For example, it is specified in standard documents that three modes for discarding CSI, mode #1 for discarding CSI, mode #2 for discarding CSI, and mode #3 for discarding CSI. The network device configures mode #3 for discarding CSI for the terminal equipment, and 2 bits are needed to describe the mode for discarding CSI. For another example, two modes for discarding CSI are agreed upon by the network device and the terminal equipment, mode A for discarding CSI and mode B for discarding CSI. Both the network device and the terminal equipment are aware of the two modes for discarding and their numbers. The terminal equipment decides to use mode A for discarding CSI, and as both the network device and the terminal equipment are aware of contents of mode A for discarding CSI, the terminal equipment needs only to report the number “A” to the network device. For example, 1 bit may be used to describe the numbers of the modes for discarding CSI, wherein bit “1” may be used to describe “mode A for discarding CSI”, and bit “0” may be used to describe “mode B for discarding CSI”. The terminal equipment reports bit ‘1’ to the network device for the mode for discarding CSI that is selected by it.

Embodiment 1 shall be further described below with reference to Example 1, Example 2 and Example 3.

### Example 1

In Example 1, a mode for discarding CSI may be configured by the network device, or may be determined and reported to the network device by the terminal equipment, or may be specified in standards. Specific implementations are as described above, which shall not be repeated herein any further.

In some implementations, the network device configure an allocation method for an allowable maximum value of a bitwidth of AI/ML-based precoding matrix information of downlink transmission.

For a case where there is only one downlink transmission layer, the allowable maximum value of a bitwidth of AI/ML-based precoding matrix information configured by the network device is an allowable maximum value of a bitwidth of AI/ML-based precoding matrix information of the downlink transmission.

For a case where there are more than one downlink transmission layer, the allowable maximum value of a bitwidth of AI/ML-based precoding matrix information configured by the network device is a sum of an allowable maximum value of a bitwidth of precoding vector information of an AI/ML-based transmission layer of all transmission layers of the more than one downlink transmission layer.

The allocation method for an allowable maximum value of a bitwidth of AI/ML-based precoding matrix information for the more than one downlink transmission layer by the network device includes:
method 1: that the allowable maximum values of the bitwidths of the precoding vector information of all the transmission layers are identical, and furthermore, the allowable maximum values of the bitwidths of the precoding vector information of all the transmission layers may be identical and fixed;
method 2: allowable maximum values of bitwidths of precoding vector information of at least two transmission layers are different; and
method 3: one or more first schemes, wherein at least one first scheme includes information on the allowable maximum value of the bitwidth of the precoding vector information of each transmission layer in all the transmission layers, wherein, in method 3, at least one downlink transmission layer may be configured with two or more first schemes.

In method 2, the network device configures the terminal equipment that allowable maximum values of bitwidths of precoding vector information of a transmission layer of at least two transmission layers are different, but does not configure an operation scheme (i.e. the second scheme). There may be one or more second schemes. The second scheme may be determined by the terminal equipment and reported to the network device.

The second scheme may be a scheme selected from more than one candidate second scheme, and may be determined by the terminal equipment, or may be agreed upon by the network device and the terminal equipment, or may be specified in a standard document. For example, there are 4 layers of downlink transmission, that is, M=4, and the number of subbands is 12. The network device configures that the allowable maximum value of the bitwidth of the AI/ML-based precoding matrix information is C=370 bits.

The network device configures the terminal equipment with numbers of allocation methods for an allowable maximum value of a bitwidth of AI/ML-based precoding matrix information of downlink transmission, i.e. numbers to which scheme 1, method 2 or method 3 corresponds. As there are three allocation methods, they may be described by using 2 bits, for example, bit descriptions of scheme 1, method 2 or method 3 may be 00, 01, and 10, respectively. For example, the allocation method for an allowable maximum value of a bitwidth of AI/ML-based precoding matrix information configured by the network device for the terminal equipment is method 2, i.e. “allowable maximum values of bitwidth of precoding vector information of an AI/ML-based transmission layer of at least two transmission layers are different”, which is described by using a bit sequence “01”. The terminal equipment reports an operation scheme (i.e. the second scheme) of the allocation method for an allowable maximum value of a bitwidth of AI/ML-based precoding matrix information to the network device, and the second scheme may be one of the candidate second schemes shown in Table 5. Table 5 may be specified in standards, or may be agreed upon by the network device and the terminal equipment; however, it is not limited thereto.

In Table 5, two candidate second schemes are provided for each possible downlink transmission layer.

TABLE 5

| Number M | | |
|---|---|---|
| of downlink | | |
| transmission | | |
| layers | Candidate second scheme 1 | Candidate second scheme 2 |
| 2 | An allowable maximum value of a | An allowable maximum value of a |
| | bitwidth of precoding vector | bitwidth of precoding vector |
| | information of an AI/ML-based | information of an AI/ML-based |
| | transmission layer of a first layer is | transmission layer of a first layer is |
| | ┌0.6C┐, and an allowable maximum | ┌0.55C┐, and an allowable maximum |
| | value of a bitwidth of precoding vector | value of a bitwidth of precoding vector |
| | information of an AI/ML-based | information of an AI/ML-based |
| | transmission layer of a second layer is | transmission layer of a second layer is |
| | C − ┌0.6C┐. | C − ┌0.55C┐. |
| 3 | An allowable maximum value of a | An allowable maximum value of a |
| | bitwidth of precoding vector | bitwidth of precoding vector |
| | information of an AI/ML-based | information AI/ML-based |
| | transmission layer of a first layer is | transmission layer of a first layer is |
| | ┌0.5C┐, an allowable maximum value | ┌0.52C┐, an allowable maximum value |
| | of a bitwidth of precoding vector | of a bitwidth of precoding vector |
| | information of an AI/ML-based | information of an AI/ML-based |
| | transmission layer of a second layer is | transmission layer of a second layer is |
| | ┌0.3C┐, and an allowable maximum | ┌0.31C┐, and an allowable maximum |
| | value of a bitwidth of precoding vector | value of a bitwidth of precoding vector |
| | information of an AI/ML-based | information of an AI/ML-based |
| | transmission layer of a third layer is | transmission layer of a third layer is |
| | C − ┌0.5C┐ − ┌0.3C┐. | C − ┌0.52C┐ − ┌0.31C┐. |
| 4 | An allowable maximum value of a | An allowable maximum value of a |
| | bitwidth of precoding vector | bitwidth of precoding vector |
| | information of an AI/ML-based | information of an AI/ML-based |
| | transmission layer of a first layer is | transmission layer of a first layer is |
| | ┌0.4C┐, an allowable maximum value | ┌0.39C┐, an allowable maximum value |
| | of a bitwidth of precoding vector | of a bitwidth of precoding vector |
| | information of an AI/ML-based | information of an AI/ML-based |
| | transmission layer of a second layer is | transmission layer of a second layer is |
| | ┌0.3C┐, an allowable maximum value | ┌0.25C┐, an allowable maximum value |
| | of a bitwidth of precoding vector | of a bitwidth of precoding vector |
| | information of an AI/ML-based | information of an AI/ML-based |
| | transmission layer of a third layer is | transmission layer of a third layer is |
| | ┌0.5(C − ┌0.4C┐ − ┌0.3C┐)┐, and an | ┌0.21C┐, and an allowable maximum |
| | allowable maximum value of a | value of a bitwidth of precoding vector |
| | bitwidth of precoding vector | information of an AI/ML-based |
| | information of an AI/ML-based | transmission layer of a fourth layer is |
| | transmission layer of a fourth layer is | C − ┌0.39C┐ − ┌0.25C┐ − ┌0.21C┐. |
| | C − C − ┌0.4C┐ − ┌0.3C┐ − ┌0.5(C − | |
| | ┌0.4C┐ − ┌0.3C┐)┐. | |

Where, C=370 bits is a sum of the allowable maximum values of the bitwidths of the precoding vector information of an AI/ML-based transmission layer of all the downlink transmission layers. The terminal equipment decides to use candidate second scheme 1 (i.e. taking candidate second scheme 1 as the second scheme), and as M=4, the second scheme is “an allowable maximum value ┌0.4 C┐=148 bits of a bitwidth of precoding vector information of an AI/ML-based transmission layer of the first layer, an allowable maximum value ┌0.3 C┐=111 bits of a bitwidth of precoding vector information of an AI/ML-based transmission layer of the second layer, an allowable maximum value ┌0.5 (C−┌0.4C┐−┌0.3 C┐)┐=56 bits of a bitwidth of precoding vector information of an AI/ML-based transmission layer of the third layer, an allowable maximum value C−┌0.4 C┐−┌0.3 C┐−┌0.5 (C−┌0.4 C┐−┌0.3 C┐)┐=55 bits of a bitwidth of precoding vector information of an AI/ML-based transmission layer of the fourth layer”.

For another example, the allocation method for an allowable maximum value of a bitwidth of AI/ML-based precoding matrix information configured by the network device for the terminal equipment is method 2, i.e. allowable maximum values of bitwidth of precoding vector information of an AI/ML-based transmission layer of at least two transmission layers are different, which is described by using a bit sequence “01”. The terminal equipment determines that the second scheme of the allocation method for an allowable maximum value of a bitwidth of AI/ML-based precoding matrix information is not given by Table 5, but is determined the terminal equipment, which is “an allowable maximum value of a bitwidth of precoding vector information of an AI/ML-based transmission layer of the first layer is 120 bits, an allowable maximum value of a bitwidth of precoding vector information of an AI/ML-based transmission layer of the second layer is 100 bits, an allowable maximum value of a bitwidth of precoding vector information of an AI/ML-based transmission layer of the third layer is 80 bits, an allowable maximum value of a bitwidth of precoding vector information of an AI/ML-based transmission layer of the fourth layer is 70 bits”, and reports the second scheme to the network device.

For a further example, the allocation method for an allowable maximum value of a bitwidth of AI/ML-based precoding matrix information configured by the network device for the terminal equipment is method 2, i.e. allowable maximum values of bitwidth of precoding vector information of an AI/ML-based transmission layer of at least two transmission layers are different, which is described by using a bit sequence “01”. The terminal equipment determines that the second scheme of the allocation method 2 for an allowable maximum value of a bitwidth of AI/ML-based precoding matrix information is determined according to the AI/ML-based CSI generation portion selected by the terminal equipment. For a case where CSI discarding is needed, one example is that the number of uplink resources available for reporting AI/ML-based precoding matrix information is less than the allowable maximum value of the bitwidth of the AI/ML-based precoding matrix information, and a mode of discarding the CSI is as described above, which shall not be repeated herein any further.

The terminal equipment reports the information on the AI/ML-based CSI generation portion selected by it to the network device, and example of the information on the AI/ML-based CSI generation portion may be found in some implementations in Example 2 given below, which shall not be repeated herein any further.

One or more of the first schemes in method 3 may be specified by the network device, or may be specified in standards, or may be agreed upon by the network device and the terminal equipment; however, it is not limited thereto. For example, there are M=4 layers of downlink transmission, and the number N_{sb} of subbands is 13. The network device configures the terminal equipment that the allowable maximum value of the bitwidth of the AI/ML-based precoding matrix information is 300 bits, and configures that the allocation method for an allowable maximum value of a bitwidth of AI/ML-based precoding matrix information is method 3, i.e. “one or more first schemes”, which is described by using a bit sequence “10”. Possible operation schemes may be given in Table 6. As described above, Table 6 may be specified in standards, or may be agreed upon by the network device and the terminal equipment, or may be specified by the network device;

however, it is not limited thereto. There may be a possible operation scheme that is similar to Table 6 for each combination of the number M of layers of downlink transmission and the number N_{sb} of subbands. Being similar to Table 6 may be specified in standards, or may be agreed upon by the network device and the terminal equipment, or may be specified by the network device; however, it is not limited thereto.

TABLE 6

| Allowable maximum value | | |
|---|---|---|
| of a bitwidth of AI/ML-based | | |
| precoding matrix information | First scheme 1 | First scheme 2 |
| 280 bits | 100, 80, 50, 50 | 100, 80, 60, 40 |
| 300 bits | 100, 80, 60, 60 | 110, 85, 60, 45 |
| 320 bits | 120, 90, 55, 55 | 120, 100, 60, 40 |

The network device configures the first scheme 1 of the allocation method 3 for an allowable maximum value of a bitwidth of AI/ML-based precoding matrix information, hence, the allocation method for an allowable maximum value of a bitwidth of AI/ML-based precoding matrix information is: an allowable maximum value of a bitwidth of precoding vector information of an AI/ML-based transmission layer of the first layer is 100 bits, an allowable maximum value of a bitwidth of precoding vector information of an AI/ML-based transmission layer of the second layer is 80 bits, an allowable maximum value of a bitwidth of precoding vector information of an AI/ML-based transmission layer of the third layer is 60 bits, an allowable maximum value of a bitwidth of precoding vector information of an AI/ML-based transmission layer of the fourth layer is 60 bits.

According to the allocation method for an allowable maximum value of a bitwidth of AI/ML-based precoding matrix information of downlink transmission and/or the first scheme and/or the second scheme, the terminal equipment may select one or more AI/ML models. The terminal equipment reports the information on the AI/ML models it uses to the network device, and the network device may find an AI/ML decoding model paired with the AI/ML model according to this information. Implementation of the information on AI/ML models is as described above, which shall not be repeated herein any further here.

In some implementations, there is only one layer of downlink transmission. According to the allocation method for an allowable maximum value of a bitwidth of AI/ML-based precoding matrix information of downlink transmission and/or the first scheme and/or the second scheme, the terminal equipment may select one or more AI/ML models. The terminal equipment reports the information on the AI/ML models it uses, for example, based on AI/ML model #1, and for another example, based on AI/ML encoder #3 and quantizer #2.

In some implementations, in a case where there are more than one layer of downlink transmission, at least two layers use different AI/ML models (including a case where the numbers of feedback bits are identical but AI/ML encoders and quantizers are different), and at this time, the terminal equipment reports information on an AI/ML model used in each layer (traversing cases of consisting of one part, two parts and three parts); or, all transmission layers use identical AI/ML models, and at this time, the terminal equipment reports information on the AI/ML models (traversing cases of consisting of one part, two parts and three parts, and at this time, as AI/ML models of all layers are identical, information on only one AI/ML model may be reported).

The terminal equipment reports a method in which the CSI is generated to the network device, namely, one of “at least two layers use different AI/ML models” and “all transmission layers use identical AI/ML models”, which may be described by using 1 bit.

In some implementations, an allowable maximum value(s) of bitwidth(s) of AI/ML-based precoding vector information of one or more transmission layers may possibly be less than the number of bits output by the AI/ML model of the transmission layer. Therefore, an output bit sequence of the AI/ML model of the layer need to be processed, so that a length of the processed output bit sequence of the AI/ML model of the layer is equal to the allowable maximum value of the bitwidth of the precoding vector information of an AI/ML-based transmission layer of the transmission layer. For example, the processing may be truncating the output bit sequence of the AI/ML model of the layer. The truncating may be deleting some bits, the bits being specified in standards, or being agreed upon by the network device and the terminal equipment in advance, or being specified and configured by the network device, or being determined and reported by the terminal equipment; however, it is not limited thereto. For example, it is specified in standards that the bits are last few bits of the output bit sequence of the AI/ML model, and the number of the last few bits is equal to a length of the output bit sequence of the AI/ML model of the layer minus the allowable maximum value of the bitwidth of the precoding vector information of an AI/ML-based transmission layer of the layer. The network device supplements lengths of the bits with bits of a number equal to the number of the few bits, and the bits of a number equal to the number of the few bits may be all 0s, or all 1s, or a bit sequence specified in standards or pre-defined by the network device and the terminal equipment. The length-supplemented bit sequence is input into an AI/ML reconstruction model paired with the AI/ML model to obtain recovered channel information. The network device learns the allocation method and scheme of the bitwidth of the AI/ML-based precoding matrix information, and also learns the AI/ML models used by all the transmission layers (i.e. numbers of feedback bits), hence, the network device may determine the number of 0s or 1s that shall be supplemented, and operations at the network device side are unambiguous.

For a case where CSI discarding is needed, one example is that the number of uplink resources available for reporting AI/ML-based precoding matrix information is less than the allowable maximum value of the bitwidth of the AI/ML-based precoding matrix information, and a mode of discarding the CSI is as described above, which shall not be repeated herein any further.

### Example 2

In some implementations, the network device configures the information on the AI/ML model (i.e. the CSI generation model) used by the terminal equipment. The information on the AI/ML model may contain two or three parts. And furthermore, the information on the AI/ML model may be composed of only one part, that is, the AI/ML encoder and quantizer may be as a whole to label information, which shall not repeated herein any further.

In a case where there are at least two layers of downlink transmission, the at least two layers of downlink transmission use different AI/ML models (such as a case where numbers of feedback bits are identical, but AI/ML encoders and quantizers are different), or use identical AI/ML encoders but different quantizers, or the at least two layers of downlink transmission use identical AI/ML models.

In some implementations, it may be that the allowable maximum values of the bitwidths of the precoding vector information of an AI/ML-based transmission layer of all transmission layers are identical, or the allowable maximum values of the bitwidths of the precoding vector information of an AI/ML-based transmission layer of at least two layers are different. Even if all layers use identical AI/ML models, the allowable maximum values of the bitwidths of the precoding vector information of an AI/ML-based transmission layer of at least two layers are different, for example, truncation may be performed on the end(s) of CSI of one or more layers.

In some implementations, the allowable maximum values of the bitwidths of the precoding vector information of an AI/ML-based transmission layer of all transmission layers are configured by the network device; or, the allowable maximum values of the bitwidths of the precoding vector information of an AI/ML-based transmission layer of all transmission layers are specified in standard; or, the allowable maximum values of the bitwidths of the precoding vector information of an AI/ML-based transmission layer of all transmission layers are determined and reported by the terminal equipment.

In some implementations, the network device configures allowable maximum values of bitwidths of precoding vector information of an AI/ML-based transmission layer of some layers, and the terminal equipment determines and reports allowable maximum values of bitwidths of precoding vector information of an AI/ML-based transmission layer of remaining layers; or, allowable maximum values of bitwidths of precoding vector information of an AI/ML-based transmission layer of some layers are specified in standards, and the network device configures allowable maximum values of bitwidths of precoding vector information of an AI/ML-based transmission layer of remaining layers; or, allowable maximum values of bitwidths of precoding vector information of an AI/ML-based transmission layer of some layers are specified in standards, and the terminal equipment determines and reports allowable maximum values of bitwidths of precoding vector information of an AI/ML-based transmission layer of remaining layers; or, allowable maximum values of bitwidths of precoding vector information of an AI/ML-based transmission layer of some layers are specified in standards, the network device configures allowable maximum values of bitwidths of precoding vector information of an AI/ML-based transmission layer of some layers (different from those layers specified in the standards), and the terminal equipment determines and reports allowable maximum values of bitwidths of precoding vector information of an AI/ML-based transmission layer of remaining layers. For example, assuming that a maximum number of layers of downlink transmission is 6, Table 7 gives objects specifying allowable maximum values of bitwidths of precoding vector information of an AI/ML-based transmission layer of the layers.

TABLE 7

| | Total one | Total two | Total three | Total four | Total five | Total six |
|---|---|---|---|---|---|---|
| | layer of | layers of | layers of | layers of | layers of | layers of |
| | downlink | downlink | downlink | downlink | downlink | downlink |
| | transmission | transmission | transmission | transmission | transmission | transmission |
| Specified | First layer | First layer | First layer, | First layer | First layer, | First layer, |
| in standards | | | second layer | | second layer | second layer |
| Configured | Inapplicable | Second layer | Inapplicable | Second layer | Fourth layer, | Third layer, |
| by the network | | | | | fifth layer | fourth layer |
| device | | | | | | |
| Determined | Inapplicable | Inapplicable | Third layer | Third layer, | Third layer | Fifth layer, |
| and reported | | | | fourth layer | | sixth layer |
| by the terminal | | | | | | |
| equipment | | | | | | |

In some implementations, for a case where an allowable maximum value of a bitwidth of precoding vector information of an AI/ML-based transmission layer of a layer is different from the number of output bits of the precoding matrix information of the layer of the AI/ML model, for example, each layer uses identical AI/ML models, but allowable maximum values of bitwidths of precoding vector information of an AI/ML-based transmission layer of at least two transmission layers are different. If the former is less than the latter, the terminal equipment may truncate the bit sequence, and a truncating position may be specified in standards, or may be agreed upon in advance by the network device and the terminal equipment, or may be configured by the network device, or may be determined and reported by the terminal equipment. For example, for the number of last bits, the number of bits is equal to the number of output bits of the AI/ML model of the layer minus the allowable maximum value of the bitwidth of the precoding vector information of an AI/ML-based transmission layer of the layer.

For a case where CSI discarding is needed, one example is that the number of uplink resources available for reporting AI/ML-based precoding matrix information is less than the allowable maximum value of the bitwidth of the AI/ML-based precoding matrix information, and a mode of discarding the CSI is as described above, which shall not be repeated herein any further.

For the case where there is only one layer of downlink transmission, the terminal equipment generates and reports CSI by using the AI/ML-based CSI generation portion configured by the network device. For the case where the output bit sequence of the AI/ML-based CSI generation portion needs to be processed, one example is that a length of the output bit sequence is greater than the allowable maximum value of the bitwidth of the AI/ML-based precoding matrix information. Description of the processing is as described above (such as truncating the bit sequence), which shall not be repeated herein any further.

For the case where CSI discarding is needed, one example is that the number of uplink resources available for reporting AI/ML-based precoding matrix information is less than the allowable maximum value of the bitwidth of the AI/ML-based precoding matrix information, and a mode of discarding the CSI is as described above, which shall not be repeated herein any further.

### Example 3

In some implementations, the network device configures information on an optional AI/ML model (i.e. the CSI generation model) for the terminal equipment, and the network device configures an optional allocation method for an allowable maximum value of a bitwidth of AI/ML-based precoding matrix information of downlink transmission. The information on an optional AI/ML model and the optional allocation method for an allowable maximum value of a bitwidth of AI/ML-based precoding matrix information are identical to those in the above embodiment, which shall not be repeated herein any further here.

For example, the network device configures the terminal equipment with an optional AI/ML model and an allocation method for an allowable maximum value of a bitwidth of AI/ML-based precoding matrix information.

The terminal equipment may possibly generate and report CSI according to the configuration of the network device, and if needed, perform truncation on the output bit sequence of the AI/ML model and/or perform CSI discarding. For example, assuming that a maximum possible number of layers of downlink transmission is N=4, in this example, the number of layers of downlink transmission is M=2, and the number of subbands is 13.

The network device configures the terminal equipment to use identical AI/ML models for the two layers, and use AI/ML model #2, with a length of an output bit sequence of 100 bits. The network device configures allocation method #3 for an allowable maximum value of a bitwidth of AI/ML-based precoding matrix information, that is, a specific operation scheme (i.e. the first scheme), which is given in Table 8.

It is assumed that the allowable maximum value of a bitwidth of AI/ML-based precoding matrix information configured by the network device is C=180 bits. The terminal equipment allocates according to an operation scheme in Table 8 to which M=2 corresponds, and obtains that an allowable maximum value of a bitwidth of precoding vector information of an AI/ML-based layer of a first layer is 101 bits, and an allowable maximum value of a bitwidth of precoding vector information of an AI/ML-based layer of a second layer is 79 bits. It can be seen that the allowable maximum value of a bitwidth of precoding vector information of an AI/ML-based layer of the first layer is greater than a length of an output bit sequence of an AI/ML model of the first layer. It is specified in standards that the truncation deletes last few bits of the bit sequence, and a length-supplementing operation of the network device side is supplementing 1 to the last few bits. Therefore, the CSI fed back by the terminal equipment to the network device is: the output bit sequence of the AI/ML model of the first layer, and former 79 bits of the output bit sequence of the AI/ML model of the second layer.

As the allocation method for an allowable maximum value of a bitwidth of AI/ML-based precoding matrix information, the allowable maximum value of a bitwidth of AI/ML-based precoding matrix information and the AI/ML model used by the terminal equipment are all configured by the network device, the network device learns that a length of an input bit sequence of the AI/ML reconstruction model paired with the AI/ML model is 100 bits. Therefore, the network device inputs the output bit sequence of the AI/ML model of the first layer into the AI/ML-based CSI reconstruction portion without processing. The network device supplements 21 bits “1” after the output bit sequence of the AI/ML model of the second layer, and inputs the length-supplemented bit sequence into the AI/ML-based CSI reconstruction portion.

Table 8 shows a specific operational scheme (i.e. the first scheme) of the allocation method for an allowable maximum value of a bitwidth of AI/ML-based precoding matrix information, applicable to the case where the number of subbands is 13.

TABLE 8

| Number M | |
|---|---|
| of downlink | |
| transmission | |
| layers | Operational schemes |
| 2 | An allowable maximum value of a bitwidth of precoding vector |
| | information of an AI/ML-based transmission layer of a first layer is |
| | ┌0.56C┐, and an allowable maximum value of a bitwidth of precoding |
| | vector information of an AI/ML-based transmission layer of a second |
| | layer is C − ┌0.56C┐ |
| 3 | An allowable maximum value of a bitwidth of precoding vector |
| | information of an AI/ML-based transmission layer of a first layer is |
| | ┌0.52C┐, an allowable maximum value of a bitwidth of precoding vector |
| | information of an AI/ML-based transmission layer of a second layer is |
| | ┌0.3C┐, and an allowable maximum value of a bitwidth of precoding |
| | vector information of an AI/ML-based transmission layer of a third layer |
| | is C − ┌0.52C┐ − ┌0.3C┐. |
| 4 | An allowable maximum value of a bitwidth of precoding vector |
| | information of an AI/ML-based transmission layer of a first layer is |
| | ┌0.39C┐, an allowable maximum value of a bitwidth of precoding vector |
| | information of an AI/ML-based transmission layer of a second layer is |
| | ┌0.24C┐, an allowable maximum value of a bitwidth of precoding vector |
| | information of an AI/ML-based transmission layer of a third layer is |
| | ┌0.22C┐, and an allowable maximum value of a bitwidth of precoding |
| | vector information of an AI/ML-based transmission layer of a fourth layer |
| | is C − ┌0.39C┐ − ┌0.24C┐ − ┌0.22C┐. |

### Embodiment 2

This embodiment is a CSI feedback process based on coexistence of a traditional codebook method and an AI/ML method, including configuration of the network device and reporting of the terminal equipment.

The network device configures the terminal equipment with available configurations for CSI feedback based on a traditional codebook method and available configurations for CSI feedback based on an AI/ML method.

In some implementations, the network device does not allow the terminal equipment to select a CSI feedback method, that is, the network device instructs the terminal equipment to perform CSI feedback, i.e. the network device selects one configuration from the two methods and signals the terminal equipment that the configuration needs overhead. For example, CSI feedback based on the traditional codebook method is referred to as CSI feedback method 1, and CSI feedback based on the AI/ML method is referred to as CSI feedback method 2. Configuring a CSI feedback method needs 1 bit to describe this configuration information. For example, the network device configures the terminal equipment to use feedback method 1, that is, performing CSI feedback based on the traditional codebook method, and bit “0” is use to describe this configuration information. The network device further configures codebooks used by the terminal equipment, which may be Rel-16 type II codebooks. For another example, the network device configures the terminal equipment to use feedback method 2, that is, performing CSI feedback based on the AI/ML method, and bit “1” is used to describe this configuration information. A CSI feedback process based on the AI/ML method is as described in Embodiment 1, which shall not be repeated herein any further here.

In some implementations, the network device allows the terminal equipment to select a CSI feedback method and report it to the network device. In this implementation, the network device may indicate a method for performing CSI feedback to the terminal equipment, or it may instruct the terminal equipment to autonomously select a CSI feedback method and report it to the network device. The network device indicate to the terminal equipment via signaling that the configuration needs overhead. For example, the terminal equipment selects a CSI feedback method and reports it, which is referred to as CSI feedback method A, the CSI feedback based on the traditional codebook method is referred to as CSI feedback method B, and the CSI feedback based on the AI/ML method is referred to as CSI feedback method C. Configuring a CSI feedback method needs 2 bits to describe this configuration information. For example, the network device configures the terminal equipment to use feedback method A, i.e. “the terminal equipment selects a CSI feedback method and reports it”, and bit “00” is used to describe this configuration information. For another example, the network device configures the terminal equipment to use feedback method B, i.e. “performing CSI feedback based on a traditional method”, and bit “01” is used to describe this configuration information. The network device further configures configuration of codebooks used by the terminal equipment, which may be Rel-15 type II codebooks. For a further example, the network device configures the terminal equipment to use feedback method C, i.e. “performing CSI feedback based on an AI/ML method”, and bit “11” is used to describe this configuration information. The CSI feedback process based on an AI/ML method is as described in Embodiment 1, which shall not be repeated herein any further here.

The embodiment of the first aspect of this disclosure provides a method for performing CSI feedback based on AI/ML and a method for performing CSI feedback based on coexistence of traditional codebooks and AI/ML. The method for performing for CSI feedback based on AI/ML has gains in both performance and cost compared to the method based on traditional codebooks, which may improve throughput of 5G and/or 6G wireless communications. The method for performing CSI feedback based on coexistence of traditional codebooks and AI/ML may be compatible with existing wireless communication standards and devices on one hand, and on the other hand, flexible switching between a traditional codebook method and an AI/ML method may be achieved. Furthermore, when the AI/ML-based CSI feedback method fails, the traditional codebook method may be reserved available, thereby ensuring normal operation of the communication system.

### Embodiments of a Second Aspect

The embodiments of the second aspect provide a channel state information (CSI) reception method, applicable to a network device, such as the network device 201 in FIG. 2. For parts in the embodiment of the second aspect that are identical to those in the embodiment of the first aspect, reference may be made to the explanations in the embodiment of the first aspect, which shall not be repeated herein any further here.

FIG. 5 is a schematic diagram of the channel state information (CSI) reception method of the second aspect of this disclosure. As shown in FIG. 5, the method includes:
operation 501: the network device transmits first information to a terminal equipment, the first information including an allowable maximum value of a bitwidth of precoding matrix information, and/or information on a channel state information (CSI) generation model.

In some embodiments, the precoding matrix information is generated based on the CSI generation model or a codebook by the terminal equipment according to configuration related to a precoding matrix configured by the network device.

In some embodiments, at least a part of the first information is configured in CSI reporting configuration.

In some embodiments, at least a part of the first information is configured in first configuration, wherein the first configuration includes a maximum value of a size of a payload of UCI, and/or the information on the CSI generation model. For example, the precoding matrix information is at least a part of information in the payload.

In some embodiments, the first information further includes: frequency domain reporting configuration, and/or, codebook configuration, wherein the frequency domain reporting configuration includes a frequency domain granularity.

In some embodiments, the first information further includes at least one of the following: a reporting configuration identifier, a channel measurement resource, a channel state information-interference measurement (CSI-IM) resource, a reporting configuration type, a reporting quantity, a time domain limit of channel measurement, a time domain limit of interference measurement, a channel quality indication (CQI) table, or group based beam reporting (groupBasedBeamReporting).

In some embodiments, the allowable maximum value of the bitwidth of the precoding matrix information is set based on the number of layers and/or a frequency domain granularity of downlink transmission between the terminal equipment and the network device.

In some embodiments, in a case where the terminal equipment has only one layer of downlink transmission, the allowable maximum value of the bitwidth of the precoding matrix information is an allowable maximum value of a bitwidth of precoding vector information of the one layer of downlink transmission; or in a case where the terminal equipment has more than one layer of downlink transmission, the allowable maximum value of the bitwidth of the precoding matrix information is a sum of allowable maximum values of bitwidths of respective precoding vector information of all transmission layers of the more than one layer of downlink transmission.

In some embodiments, in the case where the terminal equipment has more than one layer of downlink transmission, the network device configures the terminal equipment with a method for setting the allowable maximum value of the bitwidth of the precoding vector information of each transmission layer, wherein the allocation method configured by the network device includes:
method 1: the allowable maximum values of the bitwidths of the precoding vector information of all the transmission layers are identical, or,
method 2: the allowable maximum values of the bitwidths of the precoding vector information of at least two transmission layers are different; or
method 3: one or more first schemes, wherein at least one first scheme includes information on the allowable maximum value of the bitwidth of the precoding vector information of each transmission layer in all the transmission layers, wherein at least one downlink transmission layer is configured with more than two of the first schemes.

In a case where the allocation method is that the allowable maximum values of the bitwidths of the precoding vector information of at least two transmission layers are different, the network device receives information on a second scheme transmitted by the terminal equipment, wherein the second scheme is determined by the terminal equipment.

In some embodiments, the second scheme is a scheme selected by the terminal equipment from more than one candidate second scheme, the candidate second schemes being configured by the network device, or being agreed between the network device and the terminal equipment, or being specified in a protocol.

In some embodiments, in a case where the terminal equipment has only one layer of downlink transmission, the network device receives information on a CSI generation model corresponding to the one layer of downlink transmission selected by the terminal equipment according to the allowable maximum value of the bitwidth of the precoding matrix information.

In some embodiments, the network device receives information on a CSI generation model used by each layer of downlink transmission transmitted by the terminal equipment, or, when all downlink transmission layers use identical CSI generation models, the network device receives information on the identical CSI generation models transmitted by the terminal equipment, and the network device receives information indicating that all the downlink transmission layers use identical CSI generation models transmitted by the terminal equipment.

In some embodiments, when the terminal equipment has more than one layer of downlink transmission, the information on the CSI generation model includes: that at least two layers of downlink transmission use different CSI generation model; or, that all downlink transmission layers use identical CSI generation models.

In some embodiments, the allowable maximum values of the bitwidths of the precoding vector information of all the layers of downlink transmission are identical, or the allowable maximum values of the bitwidths of the precoding vector information of at two layers of downlink transmission are different from each other.

In some embodiments, the network device receives an allowable maximum value of a bitwidth of precoding vector information of at least one layer of downlink transmission determined by the terminal equipment; and/or, the network device configures the allowable maximum value of the bitwidth of the precoding vector information of at least one layer of downlink transmission; and/or, the allowable maximum value of the bitwidth of the precoding vector information of at least one layer of downlink transmission is specified in a protocol.

In some embodiments, in a case where the terminal equipment has only one layer of downlink transmission, the network device receives CSI reported by the terminal equipment, the CSI being generated by the terminal equipment by using the CSI generation model configured by the network device.

In some embodiments, when the allowable maximum value of the bitwidth of the precoding vector information of the at least one transmission layer is less than the number of bits output by the CSI generation model of the transmission layer, the terminal equipment performs the processing to ensure that the number of bits output by the CSI generation model is less than or equal to the allowable maximum value of the bitwidth of the precoding vector information of the transmission layer; and/or, when the number of uplink resources used to report the precoding matrix information is less than the allowable maximum value of the bitwidth of the precoding matrix information, the terminal equipment discards the CSI.

The network device configures a mode of processing and/or a mode of discarding for the terminal equipment; or, the network device receives information on the mode of processing and/or the mode of discarding set by the terminal equipment; or, the mode of processing and/or the mode of discarding is specified in a protocol.

In some embodiments, the network device supplements a preset bit sequence in the received CSI according to the mode of processing and/or the mode of discarding.

As shown in FIG. 5, in some embodiments, the channel state information reception method further includes:
operation 502: the network device transmits first information to a terminal equipment, the first information being used to indicate a method for generating CSI by the terminal equipment, and/or whether a method for generating CSI is selected by the terminal equipment.

The first indication information is included in the codebook configuration transmitted by the network device to the terminal equipment; or the first indication information is included in the CSI reporting configuration transmitted by the network device to the terminal equipment.

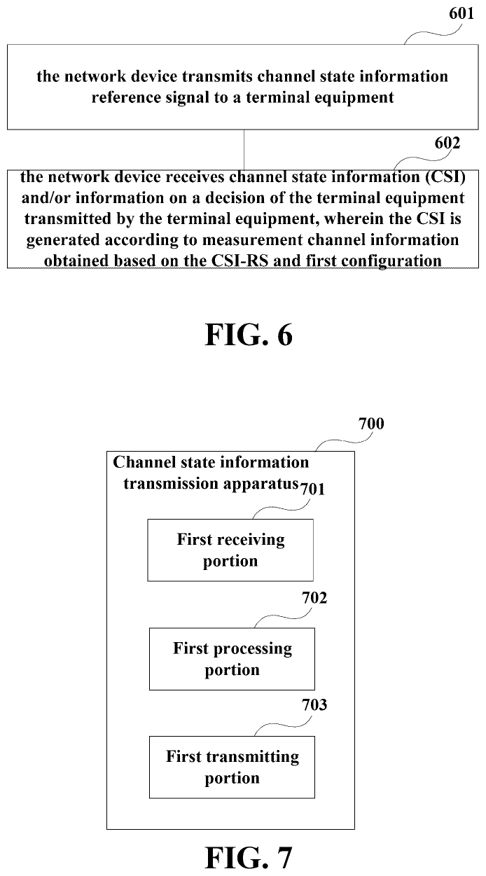

FIG. 6 is another schematic diagram of the channel state information reception method. As shown in FIG. 6, the channel state information reception method includes:
operation 601: the network device transmits channel state information reference signal to a terminal equipment; and
operation 602: the network device receives channel state information (CSI) and/or information on a decision of the terminal equipment transmitted by the terminal equipment, wherein the CSI is generated according to measurement channel information obtained based on the CSI-RS and first configuration.

In some embodiments, the first configuration includes channel state information (CSI) reporting configuration and/or configuration based on radio resource control (RRC) signaling transmission.

In some embodiments, the network device receives the CSI and/or the information on the decision of the terminal equipment based on at least one of the CSI reporting configuration, the first configuration or the configuration based on RRC signaling transmission. For example, the network device receives the CSI and/or the information on the decision of the terminal equipment via uplink control information (UCI) and/or RRC signaling.

In some embodiments, in operation 602, at least a part of information of the CSI is generated in a method based on an artificial intelligence model and/or a method based on a codebook.

In some embodiments, in operation 602, the information on the decision of the terminal equipment includes: an allocation method for an allowable maximum value of a bitwidth of precoding matrix information determined by the terminal equipment, and/or information on the CSI generation model determined by the terminal equipment.

### Embodiments of a Third Aspect

At least addressed to the same problems as the first embodiment, the embodiments of the third aspect of this disclosure provide a channel state information (CSI) transmission apparatus, applicable to a terminal equipment, corresponding to the embodiment of the first aspect.

FIG. 7 is a schematic diagram of the channel state information transmission apparatus of the embodiment of the third aspect of this disclosure. As shown in FIG. 7, a channel state information transmission apparatus 700 includes a first receiving portion 701, a first processing portion 702 and a first transmitting portion 703.

In some embodiments, the first receiving portion 701 receive first information transmitted by a network device, the first information including an allowable maximum value of a bitwidth of precoding matrix information, and/or information on a channel state information (CSI) generation model, wherein the precoding matrix information is generated by the terminal equipment based on the CSI generation model or a codebook according to configuration related to the precoding matrix configured by the network device. The CSI generation model is an artificial intelligence model.

In some embodiments, at least a part of the first information is configured in a CSI reporting configuration.

In some embodiments, at least a part of the first information is configured in a first configuration, wherein the first configuration includes a maximum value of a size of a payload of uplink control information (UCI), and/or information on the CSI generation model. For example, the precoding matrix information is at least a part of information in the payload.

In some embodiments, the allowable maximum value of the bitwidth of the precoding matrix information is set based on the number of layers and/or a frequency domain granularity of downlink transmission between the terminal equipment and the network device.

In some embodiments, when the terminal equipment has only one layer of downlink transmission, the allowable maximum value of the bitwidth of the precoding matrix information is an allowable maximum value of a bitwidth of precoding vector information of the downlink transmission layer, or, in a case where the terminal equipment has more than one downlink transmission layer, the allowable maximum value of the bitwidth of the precoding matrix information is a sum of allowable maximum values of bitwidths of precoding vector information of downlink transmission of the more than one layer.

In some embodiments, in a case where the terminal equipment has more than one layer of downlink transmission, the first processing portion 702 sets the allowable maximum values of the bitwidths of the precoding vector information of the transmission layers.

In some embodiments, the setting the allowable maximum values of the bitwidths of the precoding vector information of the transmission layers includes:
setting the allowable maximum values of the bitwidths of the precoding vector information of the transmission layers according to an allocation method configured by the network device or according to a predetermined allocation method or according to an allocation method determined by the terminal equipment.

The allocation method configured by the network device includes that:
allowable maximum values of bitwidths of precoding vector information of all transmission layers are identical, or, allowable maximum values of bitwidths of precoding vector information of at least two transmission layers are different; or
one or more first schemes, wherein at least one first scheme includes information on allowable maximum value of bitwidth of precoding vector information of each transmission layer in all transmission layers, wherein at least one downlink transmission layer may be configured with more than two first schemes.

In the case where the allocation method is that allowable maximum values of bitwidths of precoding vector information of at least two transmission layers are different, the processing portion uses a second scheme determined by the terminal equipment, and transmits information on the determined second scheme to the network device; or, the processing portion uses a second scheme that is agreed or specified in a protocol.

In some embodiments, the first processing portion 702 selects a scheme from the more than one candidate second scheme and takes it as a determined second scheme, the candidate second schemes being configured by the network device, or being agreed upon by the network device and the terminal equipment, or being specified in a protocol; or, the first processing portion 702 determines the second scheme according to the CSI generation model used by the terminal equipment.

In some embodiments, when the terminal equipment has only one downlink transmission layer, the first processing portion 702 selects a CSI generation model corresponding to the downlink transmission layer according to the allowable maximum value of the bitwidth of the precoding matrix information.

In some embodiments, the first transmitting portion 703 transmits information on the CSI generation model used for the downlink transmission layer to the network device.

When the terminal equipment has more than one layer of downlink transmission, the first processing portion selects CSI generation models for the layers of downlink transmission according to the allowable maximum value of the bitwidth of the precoding vector information of each layer of transmission.

The first transmitting portion 703 transmits information on the CSI generation model used for each layer of downlink transmission to the network device; or, when all layers of downlink transmission use identical CSI generation models, the first transmitting portion 703 transmits information on the identical CSI generation models to the network device, and the first transmitting portion 703 transmits information to the network device to indicate that all layers of downlink transmission use identical CSI generation models.

In some embodiments, in the case where the terminal equipment has more than one downlink transmission layer, the information on the CSI generation model includes that at least two downlink transmission layers use different CSI generation models, or, all downlink transmission layers use identical CSI generation models.

In some embodiments, the allowable maximum values of the bitwidths of the precoding vector information of all the downlink transmission layers are identical, or the allowable maximum values of the bitwidths of the precoding vector information of at least two downlink transmission layers are different.

In some embodiments, the first processing portion 702 determines an allowable maximum value of a bitwidth of precoding vector information of at least one downlink transmission layer, and the first transmitting portion 703 transmits the determined allowable maximum value of the bitwidth to the network device; and/or, an allowable maximum value of a bitwidth of precoding vector information of at least one downlink transmission layer is configured by the network device; and/or, an allowable maximum value of a bitwidth of precoding vector information of at least one downlink transmission layer is specified in a protocol.

In some embodiments, in a case where the terminal equipment has only one layer of downlink transmission, the first processing portion of the apparatus generates CSI by using the CSI generation model configured by the network device, and the first transmitting portion of the apparatus reports the CSI to the network device.

When an allowable maximum value of a bitwidth of precoding vector information of at least one transmission layer is less than the number of bits outputted by a CSI generation model of the transmission layer, the first processing portion 702 of the apparatus performs processing to make the number of bits outputted by the CSI generation model be less than or equal to the allowable maximum value of the bitwidth of the precoding vector information of the transmission layer; and/or, the first processing portion 702 discards the CSI when the number of uplink resources used to report the precoding matrix information is less than the allowable maximum value of the bitwidth of the precoding vector information.

In some embodiments, a mode for the processing and/or a mode for discarding is/are set by the terminal equipment and transmitted to the network device; or, the mode for the processing and/or the mode for discarding is/are configured by the network device or is/are specified in a protocol.

In some embodiments, the first information further includes frequency domain reporting configuration, and/or codebook configuration, wherein the frequency domain reporting configuration includes a frequency domain granularity.

In some embodiments, the first information further includes at least one of the following information:
a reporting configuration identifier, a channel measurement resource, a channel state information-interference measurement (CSI-IM) resource, a reporting configuration type, a reporting quantity, a time domain limit of channel measurement, a time domain limit of interference measurement, a channel quality indication (CQI) table, or group based beam reporting (groupBasedBeamReporting).

In some embodiments, the first processing portion 702 generates CSI according to an allocation method for an allowable maximum value of a bitwidth of precoding vector information configured by the network device and the CSI generation model configured by the network device, and the first transmitting portion 703 reports the CSI to the network device.

In some embodiments, the first receiving portion 701 further receives first indication information transmitted by the network device, the first indication information being used to indicate a method for generating CSI by the terminal equipment, and/or whether a method for generating CSI is selected by the terminal equipment.

The first indication information is included in the codebook configuration transmitted by the network device to the terminal equipment; or, the first indication information is included in the CSI reporting configuration transmitted by the network device to the terminal equipment.

In some embodiments, the first receiving portion 701 receives a channel state information reference signal (CSI-RS) transmitted by the network device; the first processing portion 702 measures channel information based on the CSI-RS and first configuration, and generates CSI; and the first transmitting portion 703 transmits the CSI and/or information on a decision of the terminal equipment to the network device.

In some embodiments, the first configuration includes channel state information (CSI) reporting configuration and/or configuration based on radio resource control (RRC) signaling transmission.

The first transmitting portion 703 transmits the CSI and/or information on a decision of the terminal equipment to the network device based on at least one of CSI reporting configuration, the first configuration or configuration of RRC signaling transmission. For example, the first transmitting portion 701 transmits the CSI and/or the information on a decision of the terminal equipment to the network device via uplink control information (UCI) and/or RRC signaling.

In some embodiments, at least a part of information of the CSI is generated in a method based on an artificial intelligence model and/or a method based on codebooks.

In some embodiments, the information on a decision of the terminal equipment includes an allocation method of an allowable maximum value of a bitwidth of precoding matrix information determined by the terminal equipment, and/or information on a CSI generation model determined by the terminal equipment.

### Embodiments of a Fourth Aspect

The embodiments of the fourth aspect of this disclosure provide a channel state information (CSI) reception apparatus, applicable to a network device, corresponding to the method in the embodiment of the second aspect.

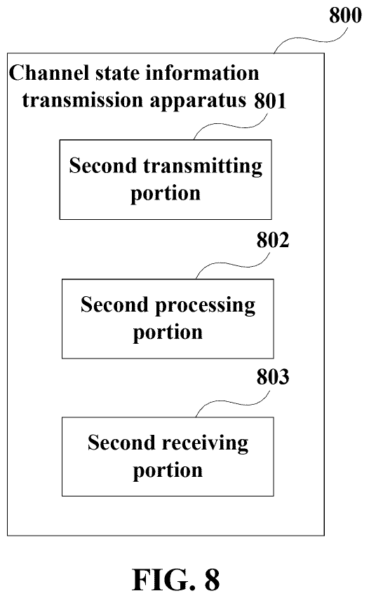

FIG. 8 is a schematic diagram of the channel state information reception apparatus of the embodiment of the fourth aspect of this disclosure. As shown in FIG. 8, an apparatus 800 includes a second transmitting portion 801, a second processing portion 802 a second receiving portion 803. In some embodiments, the second transmitting portion 801 transmits first information to a terminal equipment, the first information including an allowable maximum value of a bitwidth of precoding matrix information, and/or information on a channel state information (CSI) generation model.

The precoding matrix information is generated based on the CSI generation model or a codebook by the terminal equipment according to configuration related to a precoding matrix configured by the network device, wherein the CSI generation model is an artificial intelligence model.

In some embodiments, at least a part of the first information is configured in CSI reporting configuration.

In some embodiments, at least a part of the first information is configured in first configuration, wherein the first configuration includes a maximum value of a size of a payload of UCI, and/or the information on the CSI generation model. For example, the precoding matrix information is at least a part of information in the payload.

In some embodiments, the allowable maximum value of the bitwidth of the precoding matrix information is set based on the number of layers and/or a frequency domain granularity of downlink transmission between the terminal equipment and the network device.

In some embodiments, in a case where the terminal equipment has only one layer of downlink transmission, the allowable maximum value of the bitwidth of the precoding matrix information is an allowable maximum value of a bitwidth of precoding vector information of the one layer of downlink transmission; or in a case where the terminal equipment has more than one layer of downlink transmission, the allowable maximum value of the bitwidth of the precoding matrix information is a sum of allowable maximum values of bitwidths of respective precoding vector information of all transmission layers of the more than one layer of downlink transmission.

In some embodiments, in the case where the terminal equipment has more than one layer of downlink transmission, the second transmitting portion 801 configures the terminal equipment with a method for setting the allowable maximum values of the bitwidths of the precoding vector information of the transmission layers.

The allocation method configured by the network device includes that:
the allowable maximum values of the bitwidths of the precoding vector information of all the transmission layers are identical, or, the allowable maximum values of the bitwidths of the precoding vector information of at least two transmission layers are different; or
one or more first schemes, wherein at least one first scheme includes information on the allowable maximum value of the bitwidth of the precoding vector information of each transmission layer in all the transmission layers, wherein at least one downlink transmission layer is configured with more than two of the first schemes.

In some embodiments, in a case where the allocation method is that the allowable maximum values of the bitwidths of the precoding vector information of at least two transmission layers are different, the second receiving portion of the apparatus receives information on a second scheme transmitted by the terminal equipment, wherein the second scheme is determined by the terminal equipment.

In some embodiments, the second scheme is a scheme selected by the terminal equipment from more than one candidate second scheme, the candidate second schemes being configured by the network device, or being agreed between the network device and the terminal equipment, or being specified in a protocol.

In some embodiments, in a case where the terminal equipment has only one layer of downlink transmission, the second receiving portion 803 receives information on a CSI generation model corresponding to the one layer of downlink transmission selected by the terminal equipment according to the allowable maximum value of the bitwidth of the precoding matrix information.

In some embodiments, the second receiving portion 803 receives information on a CSI generation model used by each layer of downlink transmission transmitted by the terminal equipment, or, when all downlink transmission layers use identical CSI generation models, the second receiving portion 803 receives information on the identical CSI generation models transmitted by the terminal equipment, and receives information indicating that all the downlink transmission layers use identical CSI generation models transmitted by the terminal equipment.

In some embodiments, when the terminal equipment has more than one layer of downlink transmission, the information on the CSI generation model includes: that at least two layers of downlink transmission use different CSI generation model; or, that all downlink transmission layers use identical CSI generation models.

In some embodiments, the allowable maximum values of the bitwidths of the precoding vector information of all the layers of downlink transmission are identical, or the allowable maximum values of the bitwidths of the precoding vector information of at two layers of downlink transmission are different from each other.

In some embodiments, the second receiving portion 803 receives an allowable maximum value of a bitwidth of precoding vector information of at least one layer of downlink transmission determined by the terminal equipment; and/or, the second processing portion 802 configures the allowable maximum value of the bitwidth of the precoding vector information of at least one layer of downlink transmission; and/or, the allowable maximum value of the bitwidth of the precoding vector information of at least one layer of downlink transmission is specified in a protocol.

In some embodiments, in a case where the terminal equipment has only one layer of downlink transmission, the second receiving portion of the apparatus receives CSI reported by the terminal equipment, the CSI being generated by the terminal equipment by using the CSI generation model configured by the network device.

In some embodiments, the second processing portion 802 of the apparatus configures a mode of processing and/or a mode of discarding for the terminal equipment; or, the second processing portion 802 of the apparatus receives information on the mode of processing and/or the mode of discarding set by the terminal equipment; or, the mode of processing and/or the mode of discarding is specified in a protocol.

When the allowable maximum value of the bitwidth of the precoding vector information of the at least one transmission layer is less than the number of bits output by the CSI generation model of the transmission layer, the terminal equipment performs the processing to make the number of bits output by the CSI generation model be less than or equal to the allowable maximum value of the bitwidth of the precoding vector information of the transmission layer;
when the number of uplink resources used to report the precoding matrix information is less than the allowable maximum value of the bitwidth of the precoding matrix information, the terminal equipment discards the CSI.

In some embodiments, the second processing portion 802 supplements a preset bit sequence in the received CSI according to the mode of processing and/or the mode of discarding.

In some embodiments, the first configuration includes frequency domain reporting configuration and/or codebook configuration, the frequency domain reporting configuration including a frequency domain granularity.

In some embodiments, the first information further include at least one of the following:
a reporting configuration ID, a channel measurement resource, a channel state information interference measurement (CSI-IM) resource, a reporting configuration type, a report quantity (reportQuantity), a time domain restriction for channel measurement, a time domain restriction for interference measurement, a channel quality indicator (CQI) table, or group-based beam reporting (groupBasedBeamReporting).

In some embodiments, the second transmitting portion 801 transmits first indication information to the terminal equipment, the first indication information being used to indicate: the device for generating CSI by the terminal equipment, and/or whether the device for generating CSI is selected by the terminal equipment.

In some embodiments, the first indication information is included in the codebook configuration transmitted by the network device to the terminal equipment; or, the first indication information may be included in the CSI reporting configuration transmitted by the network device to the terminal equipment.

In some embodiments, the second transmitting portion 801 transmits a channel state information reference signal (CSI-RS) to the terminal equipment, and the second receiving portion 803 receives channel state information (CSI) transmitted by the terminal equipment and/or information on a decision of the terminal equipment transmitted by the terminal equipment, wherein the CSI is generated according to measurement channel information obtained based on the CSI-RS and first configuration.

In some embodiments, the first configuration includes channel state information (CSI) reporting configuration and/or configuration based on radio resource control (RRC) signaling transmission.

In some embodiments, the second receiving portion 803 receives the CSI and/or the information on the decision of the terminal equipment based on at least one of the CSI reporting configuration, the first configuration and the configuration based on RRC signaling transmission. For example, the second receiving portion 803 receives the CSI and/or the information on the decision of the terminal equipment via uplink control information (UCI) and/or RRC signaling.

In some embodiments, at least a part of information of the CSI is generated in a method based on an artificial intelligence model and/or a method based on a codebook.

In some embodiments, the information on the decision of the terminal equipment includes: an allocation method for an allowable maximum value of a bitwidth of precoding matrix information determined by the terminal equipment, and/or information on the CSI generation model determined by the terminal equipment.

### Embodiments of a Fifth Aspect

The embodiments of the fifth aspect of this disclosure provide a communication system, including a network device and a terminal equipment.

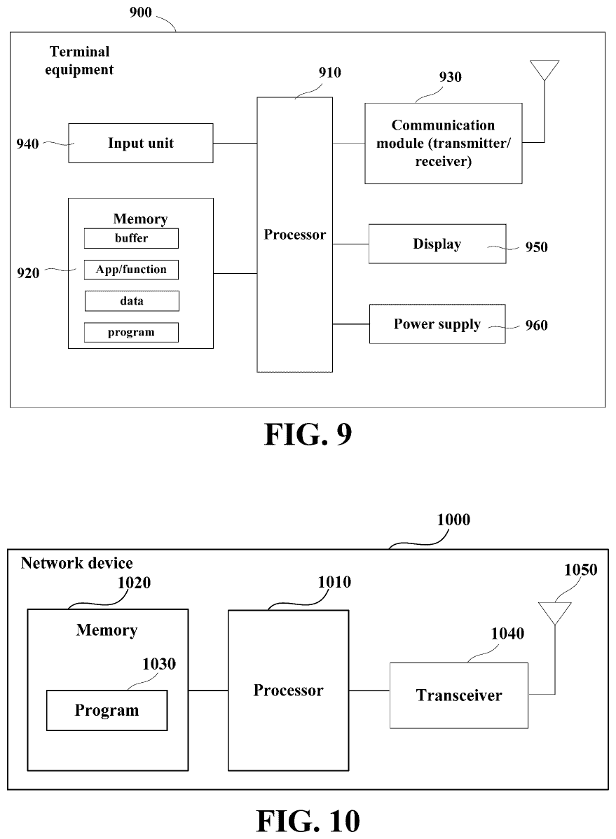

FIG. 9 is a schematic diagram of the terminal equipment of the embodiment of this disclosure. As shown in FIG. 9, a terminal equipment 900 (such as corresponding to the terminal equipment 202 in FIG. 2) may include a processor 910 and a memory 920, the memory 920 storing data and a program and being coupled to the processor 910. It should be noted that this figure is illustrative only, and other types of structures may also be used, so as to supplement or replace this structure and achieve a telecommunications function or other functions.

For example, the processor 910 may be configured to execute a program to carry out the method described in the embodiment of the first aspect.

As shown in FIG. 9, the terminal equipment 900 may further include a communication module 930, an input unit 940, a display 950, and a power supply 960; wherein functions of the above components are similar to those in the related art, which shall not be described herein any further. It should be noted that the terminal equipment 900 does not necessarily include all the parts shown in FIG. 9, and the above components are not necessary. Furthermore, the terminal equipment 900 may include parts not shown in FIG. 9, and the related art may be referred to.

FIG. 10 is a schematic diagram of the network device of the embodiment of the fifth aspect. As shown in FIG. 10, a network device 1000 (such as corresponding to the network device 201 in FIG. 2) may include a processor 1010 (such as a central processing unit (CPU) and a memory 1020, the memory 1020 being coupled to the central processing unit 1010. The memory 1020 may store various data, and furthermore, it may store a program 1030 for information processing, and execute the program under control of the central processing unit 1010.

For example, the central processing unit 1010 may be configured to execute a program to carry out the method described in the embodiment of the second aspect.

Furthermore, as shown in FIG. 10, the network device 1000 may include a transceiver 1040, and an antenna 1050, etc. Functions of the above components are similar to those in the related art, and shall not be described herein any further. It should be noted that the network device 1000 does not necessarily include all the parts shown in FIG. 10, and furthermore, the network device 1000 may include parts not shown in FIG. 10, and the related art may be referred to.

An embodiment of this disclosure provides a computer readable program, which, when executed in a terminal equipment, causes the terminal equipment to carry out the method as described in the embodiment of the first aspect.

An embodiment of this disclosure provides a computer storage medium, including a computer readable program, which causes a terminal equipment to carry out the method as described in the embodiment of the first aspect.

An embodiment of this disclosure provides a computer readable program, which, when executed in a network device, causes the network device to carry out the method as described in the embodiment of the second aspect.

An embodiment of this disclosure provides a computer storage medium, including a computer readable program, which causes a network device to carry out the method as described in the embodiment of the second aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present invention. Various variants and modifications may be made by those skilled in the art according to the spirits and principle of the present invention, and such variants and modifications fall within the scope of the present invention.

As to implementations containing the above embodiments, following supplements are further disclosed.

A method at a terminal side:
1. A channel state information transmission method, applicable to a terminal equipment, the method including:
receiving, by the terminal equipment, first information transmitted by a network device, the first information including an allowable maximum value of a bitwidth of precoding matrix information, and/or information on a channel state information (CSI) generation model.
2. The channel state information transmission method according to supplement 1, wherein,
the precoding matrix information is generated based on the CSI generation model or a codebook by the terminal equipment according to configuration related to a precoding matrix configured by the network device.
3. The channel state information transmission method according to supplement 1, wherein,
the CSI generation model is an artificial intelligence model.
4. The channel state information transmission method according to supplement 1, wherein,
at least a part of the first information is configured in CSI reporting configuration.
5. The channel state information transmission method according to supplement 1, wherein,
at least a part of the first information is configured in first configuration.
6. The channel state information transmission method according to supplement 5, wherein,
the first configuration includes a maximum value of a size of a payload of uplink control information (UCI), and/or the information on the CSI generation model.
7. The channel state information transmission method according to supplement 6, wherein,
the precoding matrix information is at least a part of information in the payload.
8. The channel state information transmission method according to supplement 1, wherein,
the allowable maximum value of the bitwidth of the precoding matrix information is set according to the number of layers and/or a frequency domain granularity of downlink transmission between the terminal equipment and the network device.
9. The channel state information transmission method according to supplement 1, wherein,
in a case where the terminal equipment has only one layer of downlink transmission, the allowable maximum value of the bitwidth of the precoding matrix information is an allowable maximum value of a bitwidth of precoding vector information of the one layer of downlink transmission; or
in a case where the terminal equipment has more than one layer of downlink transmission, the allowable maximum value of the bitwidth of the precoding matrix information is a sum of allowable maximum values of bitwidths of respective precoding vector information of all transmission layers of the more than one layer of downlink transmission.
10. The channel state information transmission method according to supplement 9, wherein,
in the case where the terminal equipment has more than one layer of downlink transmission, the method further includes:
setting the allowable maximum values of the bitwidths of the precoding vector information of the transmission layers by the terminal equipment.
11. The channel state information transmission method according to supplement 10, wherein,
the setting the allowable maximum values of the bitwidths of the precoding vector information of the transmission layers by the terminal equipment includes:
setting the allowable maximum values of the bitwidths of the precoding vector information of the transmission layers by the terminal equipment according to an allocation method configured by the network device or according to a predetermined allocation method or according to an allocation method determined by the terminal equipment.
12. The channel state information transmission method according to supplement 11, wherein,
the allocation method configured by the network device includes:
that the allowable maximum values of the bitwidths of the precoding vector information of all the transmission layers are identical, or, that the allowable maximum values of the bitwidths of the precoding vector information of at least two transmission layers are different; or
one or more first schemes, wherein at least one first scheme includes information on the allowable maximum value of the bitwidth of the precoding vector information of each transmission layer in all the transmission layers.
13. The channel state information transmission method according to supplement 12, wherein,
at least one downlink transmission layer is configured with more than two of the first schemes.
14. The channel state information transmission method according to supplement 12, wherein,
in a case where the allocation method is that the allowable maximum values of the bitwidths of the precoding vector information of at least two transmission layers are different,
the terminal equipment uses a second scheme determined by the terminal equipment, and transmits information on the determined second scheme to the network device; or
the terminal equipment uses a second scheme that is agreed, or is specified in a protocol.
15. The channel state information transmission method according to supplement 14, wherein,
the terminal equipment selects a scheme from more than one candidate second scheme and takes it as the determined second scheme, the candidate second schemes being configured by the network device, or being agreed between the network device and the terminal equipment, or being specified in a protocol; or
the terminal equipment determines the second scheme according to the CSI generation model used by the terminal equipment.
16. The channel state information transmission method according to supplement 9, wherein the method further includes:
in a case where the terminal equipment has only one layer of downlink transmission, selecting a CSI generation model corresponding to the one layer of downlink transmission by the terminal equipment according to the allowable maximum value of the bitwidth of the precoding matrix information.
17. The channel state information transmission method according to supplement 16, wherein the method further includes:
transmitting information on the CSI generation model used for the one layer of downlink transmission by the terminal equipment to the network device.
18. The channel state information transmission method according to supplement 10, wherein the method further includes:
when the terminal equipment has more than one layer of downlink transmission, selecting CSI generation models for each layer of downlink transmission by the terminal equipment according to the allowable maximum value of the bitwidth of the precoding vector information of each layer of transmission.
19. The channel state information transmission method according to supplement 18, wherein the method further includes:
transmitting information on the CSI generation model used for each layer of downlink transmission by the terminal equipment to the network device; or,
when all layers of downlink transmission use identical CSI generation models, transmitting information on the identical CSI generation models by the terminal equipment to the network device, and transmitting information by the terminal equipment to the network device to indicate that all layers of downlink transmission use identical CSI generation models.
20. The channel state information transmission method according to supplement 1, wherein,
when the terminal equipment has more than one layer of downlink transmission, the information on the CSI generation model includes:
that at least two layers of downlink transmission use different CSI generation model; or,
that all downlink transmission layers use identical CSI generation models.
21. The channel state information transmission method according to supplement 20, wherein,
the allowable maximum values of the bitwidths of the precoding vector information of all the layers of downlink transmission are identical, or the allowable maximum values of the bitwidths of the precoding vector information of at two layers of downlink transmission are different from each other.
22. The channel state information transmission method according to supplement 20, wherein,
the terminal equipment determines an allowable maximum value of a bitwidth of precoding vector information of at least one layer of downlink transmission, and transmits the determined allowable maximum value of the bitwidth to the network device; and/or
the allowable maximum value of the bitwidth of the precoding vector information of at least one layer of downlink transmission is configured by the network device; and/or
the allowable maximum value of the bitwidth of the precoding vector information of at least one layer of downlink transmission is specified in a protocol.
23. The channel state information transmission method according to supplement 1, wherein,
in a case where the terminal equipment has only one layer of downlink transmission,
the terminal equipment generates CSI by using the CSI generation model configured by the network device, and reports the CSI to the network device.
24. The channel state information transmission method according to supplement 1, wherein the method further includes:
performing processing when an allowable maximum value of a bitwidth of precoding vector information of at least one transmission layer is less than the number of bits outputted by a CSI generation model of the transmission layer, so that the number of bits outputted by the CSI generation model is less than or equal to the allowable maximum value of the bitwidth of the precoding vector information of the transmission layer; and/or
discarding the CSI when the number of uplink resources used to report the precoding matrix information is less than the allowable maximum value of the bitwidth of the precoding vector information.
25. The channel state information transmission method according to supplement 24, wherein,
a mode of the processing and/or a mode of the discarding is/are set by the terminal equipment, and is/are transmitted to the network device; or
the mode of the processing and/or the mode of the discarding is/are configured by the network device, or is/are specified in a protocol.
26. The channel state information transmission method according to supplement 1, wherein,
the first information further includes: frequency domain reporting configuration, and/or, codebook configuration.
27. The channel state information transmission method according to supplement 26, wherein,
the frequency domain reporting configuration includes a frequency domain granularity.
28. The channel state information transmission method according to supplement 1, wherein,
the first information further comprises at least one of the following:
a reporting configuration identifier, a channel measurement resource, a channel state information-interference measurement (CSI-IM) resource, a reporting configuration type, a reporting quantity, a time domain limit of channel measurement, a time domain limit of interference measurement, a channel quality indication (CQI) table, or group based beam reporting (groupBasedBeamReporting).
29. The channel state information transmission method according to supplement 1, wherein the method further includes:
generating CSI according to an allocation method for an allowable maximum value of a bitwidth of precoding vector information configured by the network device and the CSI generation model configured by the network device, and reporting the CSI to the network device, by the terminal equipment.
30. The channel state information transmission method according to supplement 1, wherein the method further includes:
further receiving, by the terminal equipment, first indication information transmitted by the network device, the first indication information being used to indicate a method for generating CSI by the terminal equipment, and/or whether a method for generating CSI is selected by the terminal equipment.
31. The channel state information transmission method according to supplement 30, wherein,
the first indication information is included in the codebook configuration transmitted by the network device to the terminal equipment; or
the first indication information is included in the CSI reporting configuration transmitted by the network device to the terminal equipment.
32. A channel state information transmission method, applicable to a terminal equipment, the method including:
receiving, by the terminal equipment, a channel state information reference signal (CSI-RS) transmitted by a network device;
measuring channel information based on the CSI-RS and first configuration, and generating CSI; and
transmitting the CSI and/or information on a decision of the terminal equipment to the network device.
33. The channel state information transmission method according to supplement 32, wherein,
the first configuration includes channel state information (CSI) reporting configuration and/or configuration based on radio resource control (RRC) signaling transmission.
34. The channel state information transmission method according to supplement 32, wherein,
the terminal equipment transmits the CSI and/or the information on the decision of the terminal equipment to the network device based on at least one of the CSI reporting configuration, the first configuration or the configuration based on RRC signaling transmission.
35. The channel state information transmission method according to supplement 34, wherein,
the terminal equipment transmits the CSI and/or the information on the decision of the terminal equipment to the network device via uplink control information (UCI) and/or RRC signaling.
36. The channel state information transmission method according to supplement 32, wherein,
at least a part of information of the CSI is generated in a method based on an artificial intelligence model and/or a method based on a codebook.
37. The channel state information transmission method according to supplement 32, wherein,
the information on the decision of the terminal equipment includes:
an allocation method for an allowable maximum value of a bitwidth of precoding matrix information determined by the terminal equipment, and/or information on the CSI generation model determined by the terminal equipment.

A method at a network side:
1. A channel state information reception method, applicable to a network device, the method including:
transmitting first information by the network device to a terminal equipment, the first information including an allowable maximum value of a bitwidth of precoding matrix information, and/or information on a channel state information (CSI) generation model.
2. The channel state information reception method according to supplement 1, wherein,
the precoding matrix information is generated based on the CSI generation model or a codebook by the terminal equipment according to configuration related to a precoding matrix configured by the network device.
3. The channel state information reception method according to supplement 1, wherein,
the CSI generation model is an artificial intelligence model.
4. The channel state information reception method according to supplement 1, wherein,
at least a part of the first information is configured in CSI reporting configuration.
5. The channel state information reception method according to supplement 1, wherein,
at least a part of the first information is configured in first configuration.
6. The channel state information reception method according to supplement 5, wherein,
the first configuration includes a maximum value of a size of a payload of uplink control information (UCI), and/or the information on the CSI generation model.
7. The channel state information reception method according to supplement 6, wherein,
the precoding matrix information is at least a part of information in the payload.
8. The channel state information reception method according to supplement 1, wherein,
the allowable maximum value of the bitwidth of the precoding matrix information is set based on the number of layers and/or a frequency domain granularity of downlink transmission between the terminal equipment and the network device.
9. The channel state information reception method according to supplement 1, wherein,
in a case where the terminal equipment has only one layer of downlink transmission, the allowable maximum value of the bitwidth of the precoding matrix information is an allowable maximum value of a bitwidth of precoding vector information of the one layer of downlink transmission; or
in a case where the terminal equipment has more than one layer of downlink transmission, the allowable maximum value of the bitwidth of the precoding matrix information is a sum of allowable maximum values of bitwidths of respective precoding vector information of all transmission layers of the more than one layer of downlink transmission.
10. The channel state information reception method according to supplement 9, wherein,
in the case where the terminal equipment has more than one layer of downlink transmission, the method further includes:
configuring the terminal equipment by the network device with a method for setting the allowable maximum value of the bitwidth of the precoding vector information of each transmission layer.
11. The channel state information reception method according to supplement 10, wherein,
the allocation method configured by the network device includes:
that the allowable maximum values of the bitwidths of the precoding vector information of all the transmission layers are identical, or, that the allowable maximum values of the bitwidths of the precoding vector information of at least two transmission layers are different; or
one or more first schemes, wherein at least one first scheme includes information on the allowable maximum value of the bitwidth of the precoding vector information of each transmission layer in all the transmission layers.
12. The channel state information reception method according to supplement 11, wherein,
at least one downlink transmission layer is configured with more than two of the first schemes.
13. The channel state information reception method according to supplement 11, wherein,
in a case where the allocation method is that the allowable maximum values of the bitwidths of the precoding vector information of at least two transmission layers are different,
receiving, by the network device, information on a second scheme transmitted by the terminal equipment, wherein the second scheme is determined by the terminal equipment.
14. The channel state information reception method according to supplement 13, wherein,
the second scheme is a scheme selected by the terminal equipment from more than one candidate second scheme, the candidate second schemes being configured by the network device, or being agreed between the network device and the terminal equipment, or being specified in a protocol.
15. The channel state information reception method according to supplement 9, wherein the method further includes:
in a case where the terminal equipment has only one layer of downlink transmission, receiving, by the network device, information on a CSI generation model corresponding to the one layer of downlink transmission selected by the terminal equipment according to the allowable maximum value of the bitwidth of the precoding matrix information.
16. The channel state information reception method according to supplement 10, wherein the method further includes:
receiving, by the network device, information on a CSI generation model used by each layer of downlink transmission transmitted by the terminal equipment; or
when all downlink transmission layers use identical CSI generation models, receiving, by the network device, information on the identical CSI generation models transmitted by the terminal equipment, and receiving, by the network device, information indicating that all the downlink transmission layers use identical CSI generation models transmitted by the terminal equipment.
17. The channel state information reception method according to supplement 1, wherein,
when the terminal equipment has more than one layer of downlink transmission, the information on the CSI generation model includes:
that at least two layers of downlink transmission use different CSI generation model; or,
that all downlink transmission layers use identical CSI generation models.
18. The channel state information reception method according to supplement 17, wherein,
the allowable maximum values of the bitwidths of the precoding vector information of all the layers of downlink transmission are identical, or the allowable maximum values of the bitwidths of the precoding vector information of at two layers of downlink transmission are different from each other.
19. The channel state information reception method according to supplement 17, wherein,
the network device receives an allowable maximum value of a bitwidth of precoding vector information of at least one layer of downlink transmission determined by the terminal equipment; and/or
configuring the allowable maximum value of the bitwidth of the precoding vector information of at least one layer of downlink transmission by the network device; and/or
the allowable maximum value of the bitwidth of the precoding vector information of at least one layer of downlink transmission is specified in a protocol.
20. The channel state information reception method according to supplement 1, wherein,
in a case where the terminal equipment has only one layer of downlink transmission,
the network device receives CSI reported by the terminal equipment, the CSI being generated by the terminal equipment by using the CSI generation model configured by the network device.
21. The channel state information reception method according to supplement 1, wherein the method further includes:
configuring a mode of processing and/or a mode of discarding by the network device for the terminal equipment; or
receiving, by the network device, information on the mode of processing and/or the mode of discarding set by the terminal equipment; or
specifying the mode of processing and/or the mode of discarding in a protocol,
wherein,
when an allowable maximum value of a bitwidth of precoding vector information of at least one transmission layer is less than the number of bits outputted by a CSI generation model of the transmission layer, the terminal equipment performs the processing, so that the number of bits outputted by the CSI generation model is less than or equal to the allowable maximum value of the bitwidth of the precoding vector information of the transmission layer; and
when the number of uplink resources used to report the precoding matrix information is less than the allowable maximum value of the bitwidth of the precoding matrix information, the terminal equipment discards the CSI.
22. The channel state information reception method according to supplement 21, wherein,
the network device supplements a predetermined bit sequence into the received CSI according to the mode of processing and/or the mode of discarding.
23. The channel state information reception method according to supplement 1, wherein,
the first information further includes: frequency domain reporting configuration, and/or, codebook configuration.
24. The channel state information reception method according to supplement 23, wherein,
the frequency domain reporting configuration includes a frequency domain granularity.
25. The channel state information reception method according to supplement 1, wherein,
the first information further includes at least one of the following:
a reporting configuration identifier, a channel measurement resource, a channel state information-interference measurement (CSI-IM) resource, a reporting configuration type, a reporting quantity, a time domain limit of channel measurement, a time domain limit of interference measurement, a channel quality indication (CQI) table, or group based beam reporting (groupBasedBeamReporting).
26. The channel state information reception method according to supplement 1, wherein the method further includes:
transmitting first indication information by the network device to the terminal equipment, the first indication information being used to indicate a method for generating CSI by the terminal equipment, and/or whether a method for generating CSI is selected by the terminal equipment.
27. The channel state information reception method according to supplement 26, wherein,
the first indication information is included in the codebook configuration transmitted by the network device to the terminal equipment; or
the first indication information is included in the CSI reporting configuration transmitted by the network device to the terminal equipment.
28. A channel state information reception method, applicable to a network device, the method including:
transmitting a channel state information reference signal (CSI-RS) by the network device to a terminal equipment; and
receiving, by the network device, channel state information (CSI) and/or information on a decision of the terminal equipment transmitted by the terminal equipment,
wherein the CSI is generated according to measurement channel information obtained based on the CSI-RS and first configuration.
29. The channel state information reception method according to supplement 28, wherein,
the first configuration includes channel state information (CSI) reporting configuration and/or configuration based on radio resource control (RRC) signaling transmission.
30. The channel state information reception method according to supplement 28, wherein,
the network device receives the CSI and/or the information on the decision of the terminal equipment based on at least one of the CSI reporting configuration, the first configuration or the configuration based on RRC signaling transmission.
31. The channel state information reception method according to supplement 30, wherein,
the network device receives the CSI and/or the information on the decision of the terminal equipment via uplink control information (UCI) and/or RRC signaling.
32. The channel state information reception method according to supplement 28, wherein,
at least a part of information of the CSI is generated in a method based on an artificial intelligence model and/or a method based on a codebook.
33. The channel state information reception method according to supplement 28, wherein,
the information on the decision of the terminal equipment includes:
an allocation method for an allowable maximum value of a bitwidth of precoding matrix information determined by the terminal equipment, and/or information on the CSI generation model determined by the terminal equipment.

What is claimed is:

1. A channel state information transmission apparatus, applicable to a terminal equipment, the apparatus comprising:
a receiver configured to receive first information transmitted by a network device, the first information comprising an allowable maximum value of a bitwidth of precoding matrix information, and/or information on a channel state information (CSI) generation model.

2. The channel state information transmission apparatus according to claim 1, wherein,
at least a part of the first information is configured in a first configuration.

3. The channel state information transmission apparatus according to claim 2, wherein,
the first configuration comprises a maximum value of a size of a payload of uplink control information (UCI), and/or information on the CSI generation model.

4. The channel state information transmission apparatus according to claim 1, wherein,
in a case where the terminal equipment has more than one layer of downlink transmission,
processor circuitry of the apparatus sets an allowable maximum value of a bitwidth of precoding vector information of each of transmission layers.

5. The channel state information transmission apparatus according to claim 4, wherein,
the setting an allowable maximum value of a bitwidth of precoding vector information of each of transmission layers comprises:
setting the allowable maximum value of the bitwidth of the precoding vector information of each of the transmission layers according to an allocation method configured by the network device or according to a predetermined allocation method or according to an allocation method determined by the terminal equipment.

6. The channel state information transmission apparatus according to claim 4, wherein,
when the terminal equipment has more than one layer of downlink transmission, the processor circuitry selects the CSI generation model for each layer of downlink transmission according to the allowable maximum value of the bitwidth of the precoding vector information of each of the transmission layers.

7. The channel state information transmission apparatus according to claim 6, wherein,
a transmitter of the apparatus transmits information on the CSI generation model used for each layer of downlink transmission to the network device; or,
when all layers of downlink transmission use identical CSI generation models, the transmitter transmits information on the identical CSI generation models to the network device, and the transmitter transmits information to the network device to indicate that all layers of downlink transmission use the identical CSI generation models.

8. The channel state information transmission apparatus according to claim 1, wherein,
in a case where the terminal equipment has only one layer of downlink transmission,
processor circuitry of the apparatus generates CSI by using the CSI generation model configured by the network device, and the transmitter of the apparatus reports the CSI to the network device.

9. The channel state information transmission apparatus according to claim 1, wherein,
when an allowable maximum value of a bitwidth of precoding vector information of at least one transmission layer is less than the number of bits outputted by a CSI generation model of the transmission layer, the processor circuitry of the apparatus performs processing to make the number of bits outputted by the CSI generation model be less than or equal to the allowable maximum value of the bitwidth of the precoding vector information of the transmission layer; and/or
the processor circuitry discards CSI when the number of uplink resources used to report the precoding matrix information is less than the allowable maximum value of the bitwidth of the precoding vector information.

10. The channel state information transmission apparatus according to claim 1, wherein,
the processor circuitry of the apparatus generate CSI according to an allocation method for an allowable maximum value of a bitwidth of precoding vector information configured by the network device and the CSI generation model configured by the network device, and a transmitter of the apparatus reports the CSI to the network device.

11. A channel state information reception apparatus, applicable to a network device, the apparatus comprising:
a transmitter configured to transmit first information to a terminal equipment, the first information comprising an allowable maximum value of a bitwidth of precoding matrix information, and/or information on a channel state information (CSI) generation model.

12. The channel state information reception apparatus according to claim 11, wherein,
at least a part of the first information is configured in first configuration.

13. The channel state information reception apparatus according to claim 12, wherein,
the first configuration comprises a maximum value of a size of a payload of uplink control information (UCI), and/or information on the CSI generation model.

14. The channel state information reception apparatus according to claim 11, wherein,
in a case where the terminal equipment has only one layer of downlink transmission, the allowable maximum value of the bitwidth of the precoding matrix information is an allowable maximum value of a bitwidth of precoding vector information of the one layer of downlink transmission; or
in a case where the terminal equipment has more than one layer of downlink transmission, the allowable maximum value of the bitwidth of the precoding matrix information is a sum of allowable maximum values of bitwidths of respective precoding vector information of all transmission layers of the more than one layer of downlink transmission.

15. The channel state information reception apparatus according to claim 14, wherein,
in the case where the terminal equipment has more than one layer of downlink transmission,
the transmitter configures the terminal equipment with a method for setting the allowable maximum values of the bitwidths of the precoding vector information of the transmission layers.

16. The channel state information reception apparatus according to claim 15, wherein,
the allocation method configured by the transmitter comprises:
that the allowable maximum values of the bitwidths of the precoding vector information of all the transmission layers are identical, or, that the allowable maximum values of the bitwidths of the precoding vector information of at least two transmission layers are different; or
one or more first schemes, wherein at least one first scheme comprises information on the allowable maximum values of the bitwidths of the precoding vector information of all the transmission layers.

17. The channel state information reception apparatus according to claim 14, wherein,
in a case where the terminal equipment has only one layer of downlink transmission, a receiver of the apparatus receives information selected, according to the allowable maximum value of the bitwidth of the precoding matrix information, by the terminal equipment, on a CSI generation model corresponding to the one layer of downlink transmission.

18. The channel state information reception apparatus according to claim 15, wherein,
the receiver of the apparatus receives information on a CSI generation model used by each layer of downlink transmission transmitted by the terminal equipment; or
when all layers of downlink transmission use identical CSI generation models, the receiver of the apparatus receives information on the identical CSI generation models transmitted by the terminal equipment, and receives information indicating that all layers of the downlink transmission use identical CSI generation models transmitted by the terminal equipment.

19. The channel state information reception apparatus according to claim 11, wherein,
the receiver portion transmits first indication information to the terminal equipment, the first indication information being used to indicate an apparatus for generating CSI by the terminal equipment, and/or whether an apparatus for generating CSI is selected by the terminal equipment.

20. The channel state information reception apparatus according to claim 19, wherein,
the first indication information is included in codebook configuration transmitted by the network device to the terminal equipment; or
the first indication information is included in CSI reporting configuration transmitted by the network device to the terminal equipment.
